(19) United States
(12) Patent Application Publication
(10) Pub. No.: US 2010/0188646 A1
(43) Pub. Date: Jul. 29, 2010

(54) DRAWING METHOD AND DRAWING APPARATUS

(75) Inventors: Katsuto Sumi, Ashigarakami-gun (JP); Kazuteru Kowada, Ashigarakami-gun (JP); Issei Suzuki, Ashigarakami-gun (JP); Takashi Fukui, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/916,225

(22) PCT Filed: May 24, 2006
(86) PCT No.: PCT/JP2006/310333

§ 371 Date: Nov. 30, 2007

(30) Foreign Application Priority Data
May 31, 2005 (JP) 2005-160769

(51) Int. Cl. G03B 27/54

(52) U.S. Cl. 355/67; 355/77

(57) ABSTRACT

A drawing method includes the steps of: moving a plurality of drawing heads relative to a drawing surface in a predetermined scanning direction, each of the drawing heads being equipped with a drawing point forming section, in which drawing elements for forming drawing points on the drawing surface are arranged two dimensionally; forming the drawing points on the drawing surface sequentially, corresponding to the movement; and performing drawing by the plurality of the drawing heads, which are arranged in a direction that intersects with the scanning direction. Reference points are formed on the drawing surface, by a reference point drawing element which is set in each of the drawing heads, and the drawing timing of each of the drawing heads is controlled such that the reference points formed thereby are arranged at predetermined positions along the scanning direction.

### TECHNICAL FIELD

The present invention relates to a drawing method and a drawing apparatus, that draw images on a drawing surface by moving a plurality of drawing heads relative to the drawing surface in a predetermined scanning direction.

### BACKGROUND ART

There are various known drawing apparatuses that form desired two dimensional patterns represented by image data on drawing surfaces.

Various exposure apparatuses that employ spatial light modulating elements such as DMD's (Digital Micromirror Devices) to modulate light beams according to image data to perform exposure have been proposed.

An exposure apparatus employing DMD's has been proposed that moves the DMD's relative to an exposure surface in a predetermined scanning direction. During the relative movement, exposure point groups exposed by the DMD's are formed in temporal sequence according to the movement, to form a desired image on the exposure surface.

As a similar type of exposure apparatus, that which comprises a plurality of exposure heads, in which DMD's are provided, and which are arranged in a direction perpendicular to a scanning direction, has been proposed. The row of exposure heads is moved relative to an exposure surface in the scanning direction. Exposure times can be shortened, by performing exposure with a line of heads having the above structure.

However, in an exposure apparatus equipped with a plurality of exposure heads as described above, each exposure head performs exposure of an image on an exposure surface based on a different coordinate system. In this type of exposure apparatus, the images which are exposed by the plurality of exposure heads become shifted in the scanning direction, and entire images cannot be exposed properly.

The present invention has been developed in view of the foregoing circumstances, and it is an object of the present invention to provide a drawing method and a drawing apparatus that employ a plurality of drawing heads to draw images, which are capable of drawing the images properly without the shifting among the drawing heads being generated.

### DISCLOSURE OF THE INVENTION

A drawing method of the present invention performs drawing based on an image data set that represents an image, by:

moving a plurality of drawing heads relative to a drawing surface in a predetermined scanning direction, each of the drawing heads being equipped with a drawing point forming section, in which drawing elements for forming drawing points on the drawing surface are arranged two dimensionally;

forming the drawing points on the drawing surface sequentially, corresponding to the movement; and

performing drawing by the plurality of the drawing heads, which are arranged in a direction that intersects with the scanning direction; wherein:

reference points are formed on the drawing surface, by a reference point drawing element which is set in each of the drawing heads; and

the drawing timing of each of the drawing heads is controlled such that the reference points formed thereby are arranged at predetermined positions along the scanning direction.

In the drawing method of the present invention, the reference point formed by each drawing head may be positioned at an end of a partial image formed by the drawing head in the direction that intersects with the scanning direction.

Correction may be administered on partial image data sets, which are input to the drawing heads, such that the end of a partial image formed by a drawing head at which the reference point is formed is connected to the end of a partial image formed by an adjacent drawing head at which the reference point is not formed.

In this case, a rotation process may be administered as the correction.

Correction may also be administered on partial image data sets, which are input to the drawing heads, such that images constituted by drawing points formed by the reference drawing elements are formed at predetermined positions along the direction that intersects the predetermined scanning direction.

Correction may also be administered on partial image data sets, which are input to the drawing heads, such that images formed on the drawing surface by adjacent drawing heads are connected in the direction that intersects the predetermined scanning direction.

In this case, an interpolation process or a pixel skipping process may be administered as the correction.

Multiple drawing may be performed on the drawing surface at N× (N being a natural number greater than or equal to 2).

A drawing apparatus of the present invention performs drawing based on an image data set that represents an image, by:

moving a plurality of drawing heads relative to a drawing surface in a predetermined scanning direction, each of the drawing heads being equipped with a drawing point forming section, in which drawing elements for forming drawing points on the drawing surface are arranged two dimensionally;

forming the drawing points on the drawing surface sequentially, corresponding to the movement; and

performing drawing by the plurality of the drawing heads, which are arranged in a direction that intersects with the scanning direction; wherein:

the plurality of drawing heads form reference points on the drawing surface, with a reference point drawing element which is set in each of the drawing heads; and

the drawing apparatus further comprises a control section, for controlling the drawing timing of each of the drawing heads such that the reference points formed thereby are arranged at predetermined positions along the scanning direction.

Each drawing head may form the reference point formed such that the reference point is positioned at an end of a partial image formed by the drawing head in the direction that intersects with the scanning direction.

The drawing apparatus may further comprise:

scanning direction correcting means, for administering correction on partial image data sets, which are input to the drawing heads, such that the end of a partial image formed by a drawing head at which the reference point is formed is connected to the end of a partial image formed by an adjacent drawing head at which the reference point is not formed.

In this case, the scanning direction correcting means may administer a rotation process as the correction.

The drawing apparatus may further comprise:

drawing point correcting means, for administering correction on partial image data sets, which are input to the drawing heads, such that images constituted by drawing points formed by the reference drawing elements are formed at predetermined positions along the direction that intersects the predetermined scanning direction.

The drawing apparatus may further comprise:

intersecting direction correcting means, for administering correction on partial image data sets, which are input to the drawing heads, such that images formed on the drawing surface by adjacent drawing heads are connected in the direction that intersects the predetermined scanning direction.

In this case, the intersecting direction correcting means may administer an interpolation process or a pixel skipping process as the correction.

The drawing apparatus may perform multiple drawing on the drawing surface at N× (N being a natural number greater than or equal to 2).

The drawing method and the drawing apparatus of the present invention form reference points, by employing the reference drawing element, which is set in advance in each drawing head. The drawing timings are controlled such that the reference points formed thereby are arranged at predetermined positions along the scanning direction. Therefore, the coordinate system of all of the drawing heads can be matched, and images can be drawn properly, without the aforementioned shifts being generated.

### BRIEF DESCRIPTION OF THE DRAWINGS

FIG. 1 is a perspective view that illustrates the outer appearance of an exposure apparatus as an embodiment of the drawing apparatus of the present invention.

FIG. 2 is a perspective view that illustrates the construction of a scanner of the exposure apparatus of FIG. 1.

FIG. 3A is a plan view that illustrates exposed regions, which are formed on a photosensitive material.

FIG. 3B is a diagram that illustrates the arrangement of exposure areas exposed by exposure heads.

FIG. 4 is a perspective view that illustrates the schematic construction of an exposure head of the exposure apparatus of FIG. 1.

FIG. 5A is a plan view that illustrates the exposure head of the exposure apparatus of FIG. 1 in detail.

FIG. 5B is a side view that illustrates the exposure head of the exposure apparatus of FIG. 1 in detail.

FIG. 6 is a partial magnified diagram that illustrates the construction of a DMD of the exposure apparatus of FIG. 1.

FIG. 7A is a perspective view for explaining the operation of the DMD.

FIG. 7B is a perspective view for explaining the operation of the DMD.

FIG. 8 is a perspective view that illustrates the construction of a fiber array light source.

FIG. 9 is a front view that illustrates the arrangement of light emitting points of laser emitting portions of the fiber array light source.

FIG. 10 is a diagram that illustrates an example of irregularities in patterns which are formed on an exposure surface, in the case that the relative positions of adjacent exposure heads are misaligned.

FIG. 11 is a plan view that illustrates the positional relationships among exposure areas of two adjacent exposure heads and slits corresponding thereto.

FIG. 12 is a diagram for explaining how the positions of light points on an exposure surface are measured by using the slits.

FIG. 13 is a diagram for explaining how irregularities in patterns which are formed on an exposure surface are improved from the example of FIG. 10, when only selected pixels are utilized.

FIG. 14 is a diagram that illustrates an example of irregularities in patterns which are formed on an exposure surface, in the case that the relative positions of adjacent exposure heads are misaligned and there is a margin of error in the mounting angles thereof.

FIG. 15 is a diagram for explaining how irregularities in patterns which are formed on an exposure surface are improved from the example of FIG. 14, when only selected pixels are utilized.

FIG. 16 is a diagram that illustrates a first example of reference exposure.

FIG. 17 is a diagram that illustrates a second example of reference exposure.

FIG. 18 is a diagram for explaining an example of a method for measuring the amount of shifting in the X direction for two exposure heads.

FIG. 19 is a diagram that illustrates an example of a reference scale.

FIG. 20A is a diagram for explaining shifting of exposed patterns exposed by two exposure heads, in the Y direction.

FIG. 20B is a diagram that illustrates exposed patterns when the exposure timings of the two exposure heads are adjusted.

FIG. 21 is a diagram for explaining a method for correcting shifting of exposed patterns exposed by two exposure heads, in the Y direction.

FIG. 22 is a diagram for explaining shifting of exposed patterns caused by installation angles of two exposure heads.

FIG. 23 is a diagram for explaining an example of a method for measuring the amount of shifting of exposed patterns caused by installation angles of two exposure heads.

FIG. 24A is a diagram for explaining an alternate method for causing patterns exposed by two exposure heads to connect in the Y direction.

FIG. 24B is a diagram for explaining an alternate method for causing patterns exposed by two exposure heads to connect in the Y direction.

FIG. 25 is a diagram for explaining an alternate method for causing patterns exposed by two exposure heads to connect in the Y direction.

FIG. 26 is a diagram for explaining an alternate method for causing patterns exposed by two exposure heads to connect in the Y direction.

FIG. 27A is a diagram that illustrates the ideal positions of exposure points to be exposed by each micro mirror.

FIG. 27B is a diagram that illustrates shifting of exposure points exposed by each micro mirror in the X direction, due to margins of error in the focusing positions of optical systems and the like.

FIG. 27C is a diagram for explaining an example of a method for correcting shifting of exposure points exposed by each micro mirror in the X direction, due to margins of error in the focusing positions of optical systems and the like.

FIG. 28A is a diagram that illustrates the ideal positions of exposure points to be exposed by each micro mirror.

FIG. 28B is a diagram that illustrates shifting of exposure points exposed by each micro mirror in the X direction, due to margins of error in the magnification ratios of optical systems and the like.

FIG. 28C is a diagram for explaining an example of a method for correcting shifting of exposure points exposed by each micro mirror in the X direction, due to margins of error in the magnification ratios of optical systems and the like.

FIG. 29 is a diagram for explaining an example of a method for correcting shifting of exposure points exposed by each micro mirror in the X direction, due to margins of error in the magnification ratios of optical systems and the like.

### BEST MODE FOR CARRYING OUT THE INVENTION

Hereinafter, an exposure apparatus 10 will be described as an embodiment of the drawing apparatus of the present invention, with reference to the attached drawings.

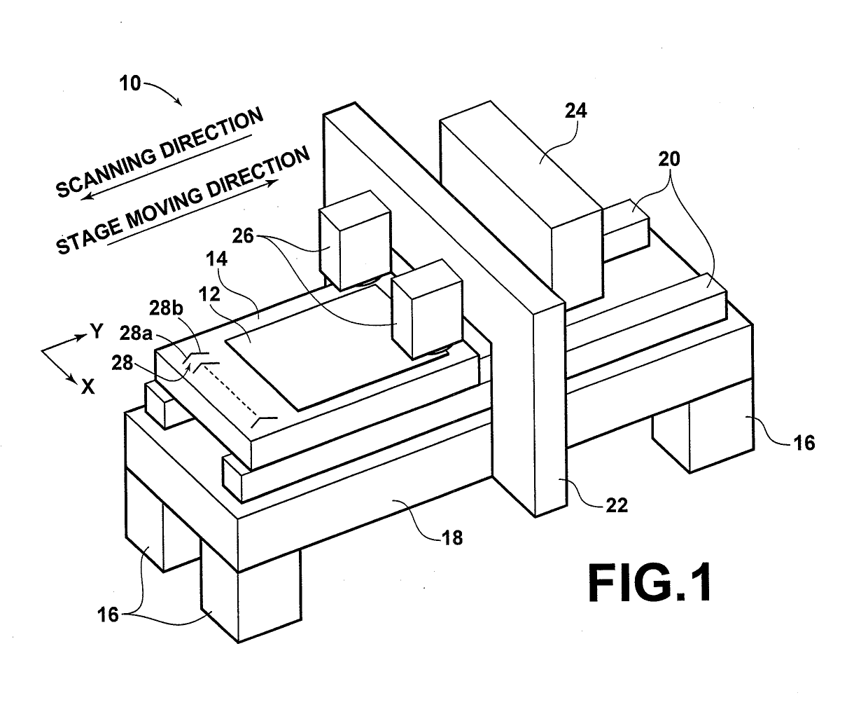

As illustrated in FIG. 1, the exposure apparatus 10 is equipped with a planar movable stage 14, for holding sheets of photosensitive material 12 thereon by suction. A thick planar mounting base 18 is supported by four legs 16. Two guides 20 that extend along the stage movement direction are provided on the upper surface of the mounting base 18. The stage 14 is provided such that its longitudinal direction is aligned with the stage movement direction, and supported by the guides 20 so as to be movable reciprocally thereon. Note that the exposure apparatus 10 is also equipped with a stage driving apparatus (not shown), for driving the stage 14 along the guides 20.

A C-shaped gate 22 is provided at the central portion of the mounting base so as to straddle the movement path of the stage 14. The ends of the C-shaped gate 22 are fixed to side edges of the mounting base 18. A scanner 24 is provided on a first side of the gate 22, and a plurality (two, for example) of sensors 26 for detecting the leading and trailing ends of the photosensitive material 12 are provided on a second side of the gate 22. The scanner 24 and the sensors 26 are individually mounted on the gate 22, and fixed above the movement path of the stage 14. Note that the scanner 24 and the sensors 26 are connected to a controller (not shown) for controlling the operations thereof. Here, the X direction and the Y direction are defined as illustrated in FIG. 1, within a plane parallel to the stage 14.

Nine equidistantly spaced L-shaped slits 28 that open toward the X direction are formed in the end of the stage 14 toward the upstream side of the scanning direction thereof. Each slit 28 is constituted by a slit 28a positions toward the upstream side and a slit 28b positioned toward the downstream side. The slits 28a and the slits 28b are perpendicular to each other. The slits 28a are disposed at angles of −45 degrees with respect to the X direction, and the slits 28b are disposed at angles of +45 degrees with respect to the X direction. A single cell photodetector (not shown) is provided within the stage 14 beneath each of the slits 28. Each photodetector is connected to a computer (not shown) that performs a usable pixel selecting process, to be described later.

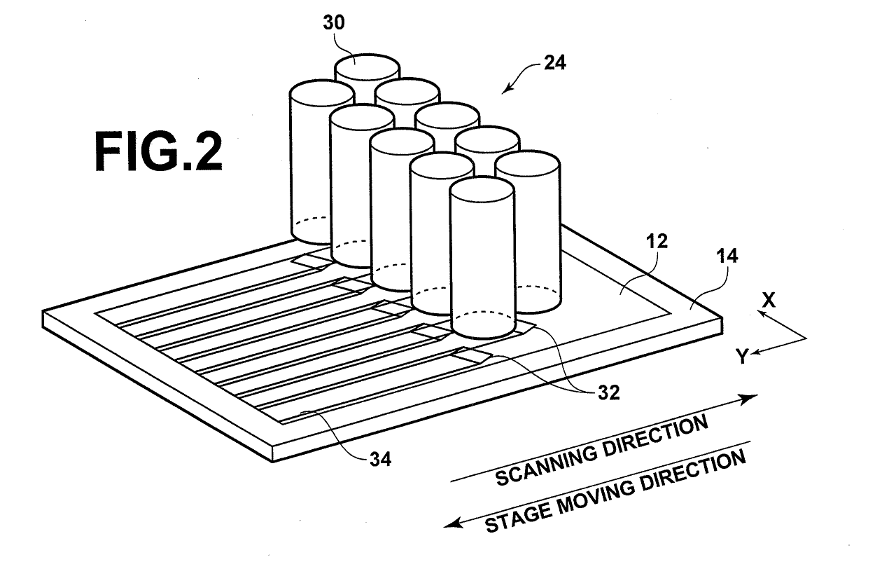

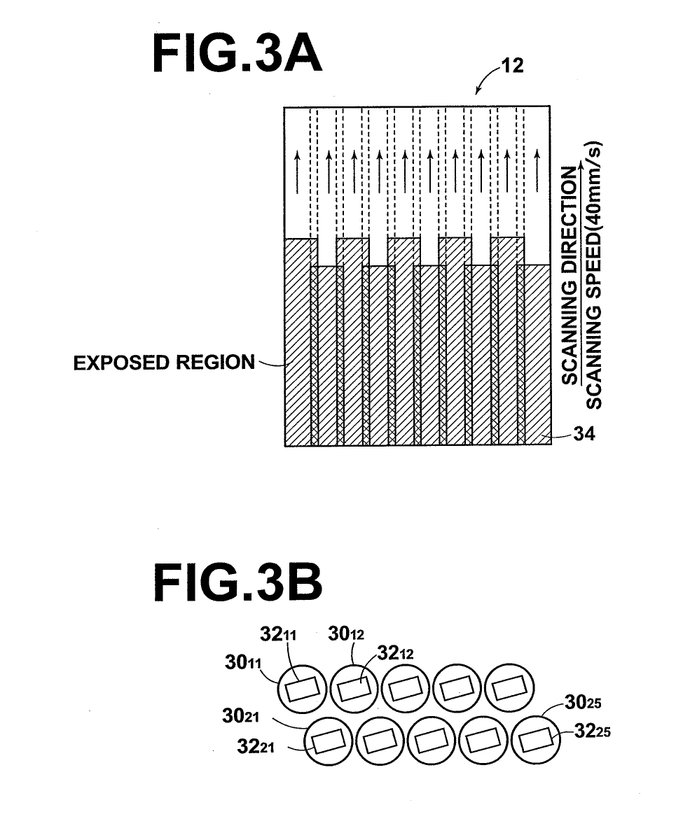

The scanner 24 is equipped with a ten exposure heads 30, arranged in an approximate matrix having 2 rows and 5 columns, as illustrated in FIG. 2 and FIG. 3B. Note that an individual exposure head arranged in an m^{th} row and an n^{th} column will be denoted as an exposure head 30ₘₙ.

Each exposure head 30 is mounted on the scanner 24 such that the direction in which the pixels rows of the DMD's 36 (Digital Micromirror Devices) therein, to be described later, are at a set angle of inclination θ with respect to the scanning direction. Accordingly, an exposure area 32 exposed by each exposure head 30 will be a rectangular area which is inclined with respect to the scanning direction. Band shaped exposed regions 34 are formed on the photosensitive material 12 by each of the exposure heads 30, accompanying the movement of the stage 14. Note that an individual exposure area, exposed by an exposure head arranged in an m^{th} row and an n^{th} column will be denoted as an exposure area 32ₘₙ.

As illustrated in FIG. 3A and FIG. 3B, each of the exposure heads 30 is provided such that each of the band shaped exposed regions 34 partially overlaps an adjacent exposed region 34. Therefore, the portion between the exposure areas 32₁₁ and 32₁₂ of the first row, which cannot be exposed thereby, can be exposed by an exposure area 32₂₁ of the second row.

Each of the exposure heads 30 is equipped with a DMD 36 (Digital Micro mirror Device) by Texas Instruments (U.S.), as a spatial light modulating element for modulating light beams incident thereon according to each pixel of image data. The DMD's 36 are connected to a controller, comprising a data processing section and a mirror drive control section. The data processing section of the controller generates control signals for controlling the drive of each micro mirror of the DMD 36 within a utilization region for each exposure head 30, based on input image data. The mirror drive control section controls the angle of a reflective surface of each micro mirror of the DMD 36 for each exposure head 30, according to the control signals generated by the data processing section.

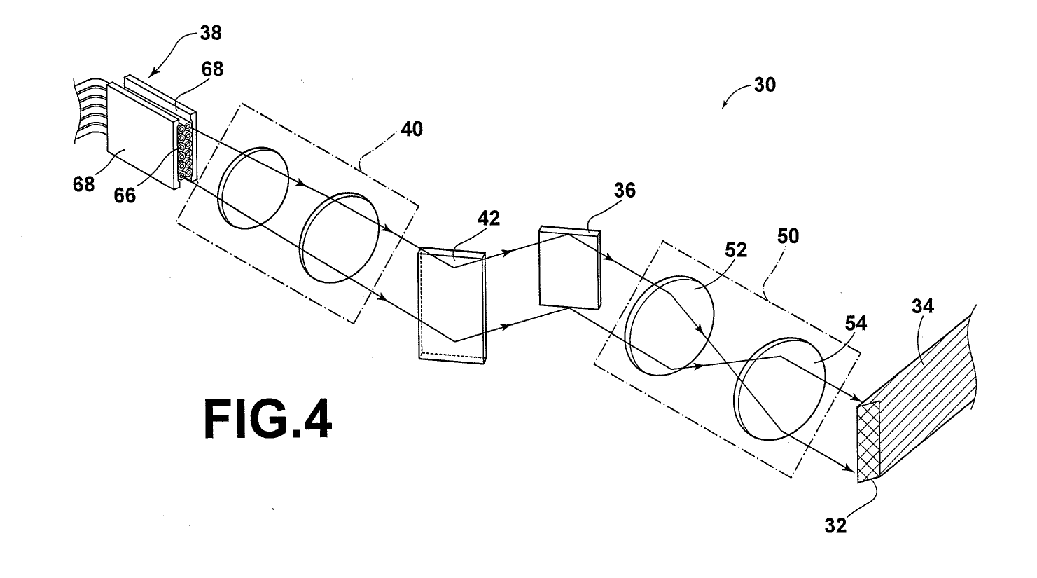

As illustrated in FIG. 4, a fiber array light source 38; a lens system 40; and a mirror 42 are provided in this order, at the light incident side of the DMD 36. The fiber array light source 38 comprises a laser emitting section, constituted by a plurality of optical fibers having their light emitting ends (light emitting points) aligned in a direction corresponding to the longitudinal direction of the exposure area 32. The lens system 40 corrects laser beams emitted from the fiber array light source 38 and focuses them onto the DMD 36. The mirror 42 reflects the laser beams, which have passed through the lens system 40, toward the DMD 36. Note that the lens system 40 is schematically illustrated in FIG. 4.

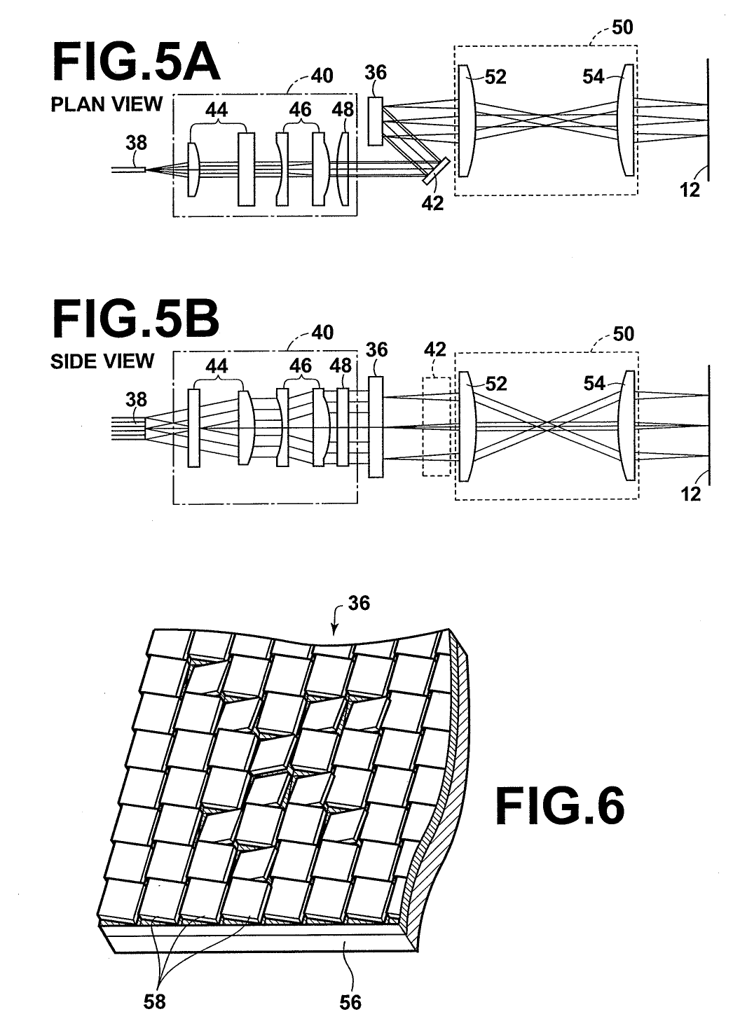

As illustrated in detail in FIG. 5, the lens system 40 comprises: a pair of lenses 44, for collimating the laser beams emitted from the fiber array light source 38; a pair of lenses 46 for correcting the collimated laser beams such that the distribution of amounts of light thereof becomes uniform; and a focusing lens 48, for focusing the laser beams, of which the distribution of the amounts of light has been caused to become uniform, onto the DMD 36.

A lens system 50, for focusing the laser beam reflected by the DMD 36 onto the photosensitive material 12, is provided on the light reflecting side of the DMD 36. The lens system 50 comprises: a pair of lenses 52 and 54, which are arranged such that the DMD 36 and the exposure surface of the photosensitive material 12 are in a conjugate relationship.

In the present embodiment, the laser beams emitted from the fiber array light source 38 are magnified at a magnification ratio of 5×, then light beams from each micro mirror of the DMD 36 are focused to approximately 5 μm by the lens system 50.

As illustrated in FIG. 6, the DMD 36 is a mirror device having a great number of micro mirrors 58, each of which constitutes a pixel, arranged in a matrix on an SRAM cell 56 (memory cell). In the present embodiment, the DMD 36 is constituted by micro mirrors 58 arranged in 768 rows of 1024 columns, but only 256 rows of the 1024 columns are drivable by the controller connected to the DMD 36. That is, only 1024×256 of the 1024×768 micro mirrors 58 are usable. The data processing speed of the DMD's 36 is limited, and the modulation speed for each line is determined proportionate to the number of utilized pixels. Therefore, the modulation speed for each line is increased by utilizing only a portion of the micro mirror columns in this manner. Each micro mirror 58 is supported by a support column, and a material having high reflectivity, such as aluminum, is deposited on the surface of the micro mirror 58 by vapor deposition. Note that in the present embodiment, the reflectivity of the micro mirrors 58 is 90% or greater, and that the arrangement pitch of the micro mirrors 58 is 13.7 μm in both the vertical and horizontal directions. In addition, the CMOS SRAM cell 56 of a silicon gate, which is manufactured in a normal semiconductor memory manufacturing line, is provided beneath the micro mirrors 58, via the support column, which includes a hinge and a yoke. The DMD 36 is of a monolithic structure.

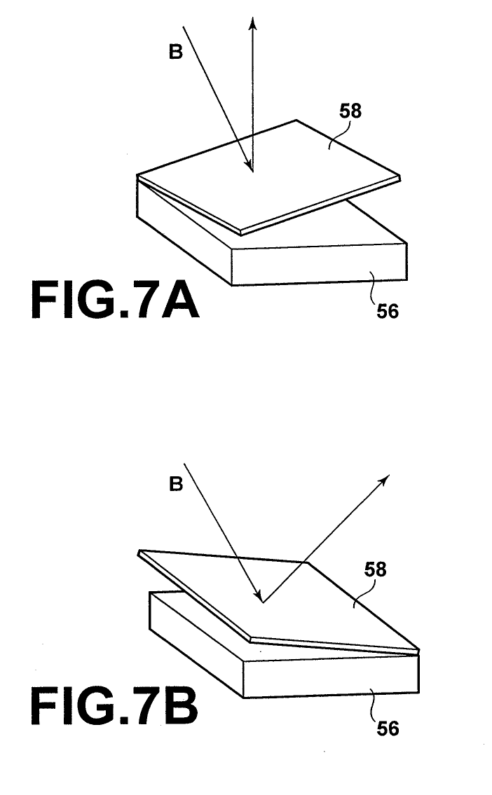

When binary signals that represent the densities of each point that constitutes a desired two dimensional pattern are written into the SRAM cell 56 of the DMD 36, the micro mirrors 58 which are supported by the support columns are tilted within a range of ±α degrees (±10 degrees, for example) with respect to the substrate on which the DMD 36 is provided, with the diagonal line as the center of rotation. FIG. 7A illustrates a state in which a micro mirror 58 is tilted +α degrees in an ON state, and FIG. 7B illustrates a state in which a micro mirror 58 is tilted −α degrees in an OFF state. Accordingly, laser beams incident on the DMD 36 are reflected toward the direction of inclination of each micro mirror 58, by controlling the tilt of each micro mirror 58 that corresponds to a pixel of the DMD 36 according to image signals, as illustrated in FIG. 6.

Note that FIG. 6 illustrates a magnified portion of a DMD 36 in which the micro mirrors 58 are controlled to be tilted at +α degrees and at −α degrees. The ON/OFF operation of each micro mirror 58 is performed by the controller, which is connected to the DMD 36. In addition, a light absorbing material (not shown) is provided in the direction toward which laser beams B reflected by micro mirrors 58 in the OFF state are reflected.

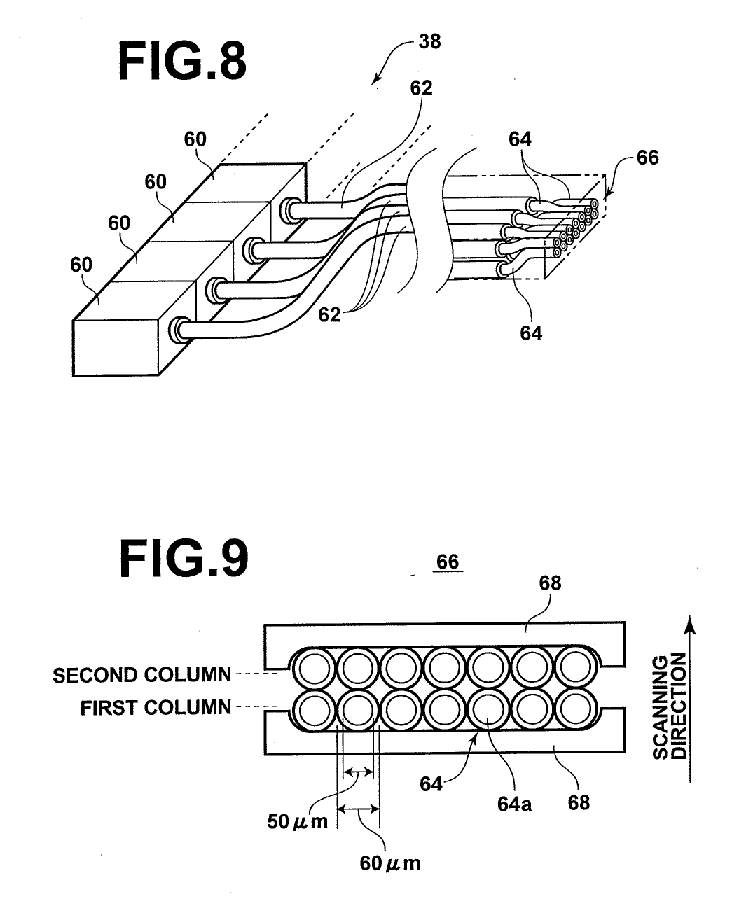

As illustrated in FIG. 8, the fiber array light source 38 is equipped with a plurality (14, for example) of laser modules 60. An end of a multi mode optical fiber 62 is coupled to each laser module 60. A multi mode optical fiber 64, having the same core diameter as the multi mode optical fiber 62 and a cladding diameter smaller than that of the multi mode optical fiber 62, is coupled to the other end of each multi mode optical fiber 62. As illustrated in detail in FIG. 9, the optical fibers 64 are arranged such that seven ends of the optical fibers 62 opposite the end at which they are coupled to the multi mode optical fibers are aligned along the main scanning direction perpendicular to the sub scanning direction. Two rows of the seven optical fibers 64 constitute a laser emitting section 66.

As illustrated in FIG. 9, the laser emitting section 66, constituted by the ends of the optical fibers 64, is fixed by being sandwiched between two support plates 68, which have flat surfaces. It is desirable for a transparent protective plate, such as that made of glass, to be placed at the light emitting end surfaces of the optical fibers 64. The light emitting end surfaces of the optical fibers 64 are likely to collect dust due to their high optical density and therefore likely to deteriorate. However, by placing the protective plate as described above, adhesion of dust to the end surfaces can be prevented, and deterioration can be slowed.

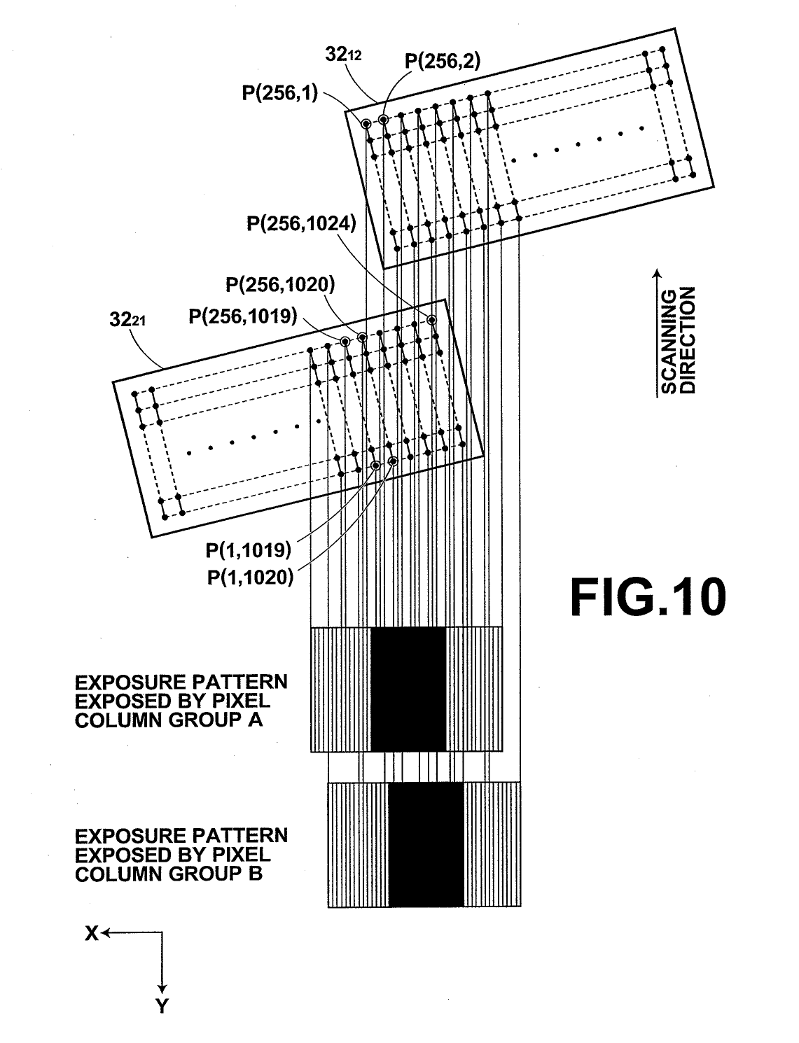

Hereinafter, an example of a utilized pixel specifying process performed by the exposure apparatus 10 of the present embodiment will be described with reference to FIGS. 10 through 13.

In the present embodiment, the exposure apparatus 10 performs a double exposure process. An angle θ_{ideal} that enables double exposure using 256 rows of 1024 micro mirrors 58 in an ideal state, in which there is no margin of error in the mounting angles of the exposure heads 30, is set as the set inclination angle for each DMD 36. This angle θ_{ideal} is derived by equation (1):

sp sin θ_{ideal}=Nδ (1)

wherein N is the number of exposures, s is the number of usable micro mirrors 58 in each pixel column, p is the pixel pitch of the usable micro mirrors 58 in the direction of the pixel row, and δ is the pixel pitch of the usable micro mirrors 58 in a direction perpendicular to the scanning direction.

Because the DMD's 36 of the present embodiment are constituted by the great number of micro mirrors 58 which are arranged in a rectangular matrix with the same pitch in both the vertical and horizontal directions, equation (2) applies.

p cos θ_{ideal}=δ 2)

Therefore, equation (1) can be rewritten as:

S tan θ_{ideal}=N (3)

In the present embodiment, s=256, and N=2 as described previously. Therefore, the angle θ_{ideal} derived from equation (3) is approximately 0.45 degrees. The exposure apparatus 10 is adjusted initially such that the mounting angle of each exposure head 30, that is, the mounting angle of each DMD 36 is θ_{ideal}.

FIG. 10 is a diagram that illustrates an example of irregularities in patterns which are formed on an exposure surface, in the case that the relative positions of adjacent exposure heads (exposure heads 30₁₂ and 30₂₁, for example) of the exposure apparatus 10 are misaligned from an ideal state in the X direction. The misalignment in the relative positions occurs due to difficulties in fine adjustments thereof.

In the following description and in the drawings which are referred to, an m^{th} light point row within each exposure area 32 will be designated as r (m), an n^{th} light point column within the exposure surface will be designated as c (n), and a light point in an m^{th} row and an n^{th} column will be designated as P (m, n). The upper portion of FIG. 10 illustrates patterns of light point groups projected onto the exposure surface of the photosensitive material 12 by usable micro mirrors 58 of the DMD's 36 of the exposure heads 30₁₂ and 30₂₁, in a state in which the stage 14 is still. The lower portion of FIG. 10 illustrates the states of exposed patterns at the connecting region between the exposure areas 32₁₂ and 32₂₁, which are formed on the exposure surface when continuous exposure is performed by moving the stage 14 in a state in which the patterns of light point groups are as those illustrated in the upper portion of FIG. 10. Note that in FIG. 10, the exposure pattern exposed by a pixel column group A, which is constituted by every other pixel column of the usable micro mirrors 58, and the exposure pattern exposed by a pixel column group B, which is constituted by the remaining pixel columns, are illustrated separately. However, the exposure pattern that appears on the actual exposure surface is that in which the two exposure patterns overlap.

In the example of FIG. 10, a redundantly exposed region is generated at the connecting portion between the exposure areas 32₁₂ and 32₂₁, that is, the pattern exposed by the pixel column group A and the pattern exposed by the pixel column group B, due to the misalignment in the relative positions of the exposure heads 30₁₂ and 30₂₁ in the X direction.

The exposure apparatus 10 of the present embodiment employs the combinations of the slits 28 and the photodetectors to detect the positions of several of the light points, from among the light points of the exposure heads 30₁₂ and 30₂₁, within the connecting portion between the exposure heads, in order to reduce the redundantly exposed region at the connecting portion between the exposure areas that appear on the exposure surface. The computer connected to the photodetectors administers a selecting process that selects micro mirrors to be used during final exposure, from among the micro mirrors that correspond to the light points within the connecting portion between the exposure heads 30₁₂ and 30₂₁, based on the results of the position detection.

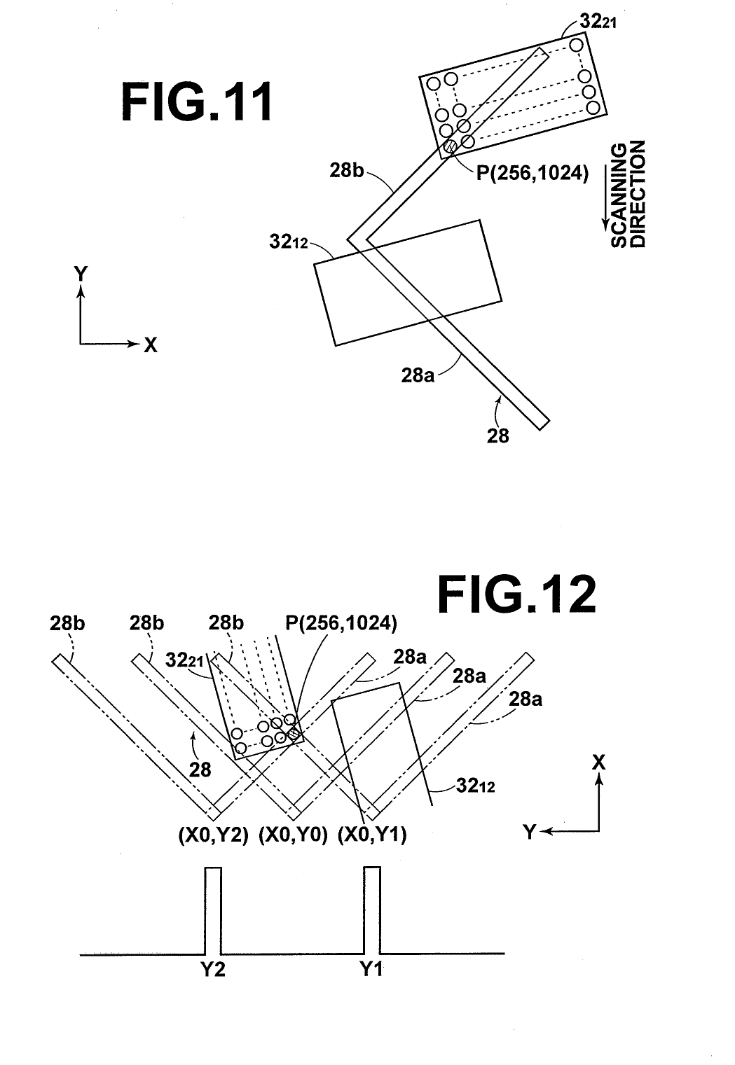

First, the position detecting process that employs the combinations of the slits 28 and the photodetectors will be described with reference to FIGS. 11 and 12. FIG. 11 is a plan view that illustrates the positional relationships among exposure areas 32₁₂ and 32₂₁, and a slit 28 corresponding thereto. As stated previously, the size of the slit 28 is sufficiently large enough to cover the redundantly exposed region between the regions 34 exposed by the exposure heads 30₁₂ and 30₂₁. That is, the slit 28 is of a size sufficiently large enough to cover the connecting region.

FIG. 12 is a diagram for explaining how the position of a light points P (256, 1024) within the exposure area 32₂₁ is measured by using the slit 28. First, the stage 14 is moved slowly with the light point P (256, 1024) in a lit state, so as to move the slit 28 relatively in the Y direction. The slit 28 is thereby positions such that the light point P (256, 1024) is positioned between the upstream slit 28a and the downstream slit 28b. At this time, the coordinates of the intersection between the slit 28a and the slit 28b are designated as (X0, Y0). The values of the coordinates (X0, Y0) are determined based on the movement distance of the stage 14, indicated by the drive signals output to the stage 14, and the position of the slit 28 in the X direction, which is known, and recorded. Next, the stage 14 is moved along the Y direction, so as to move the slit 28 relatively toward the right in FIG. 12. When the light point P (256, 1024) passes through the left side slit 28b and is detected by the photodetector, as indicated by the broken lines in FIG. 12, the stage 14 is stopped. The coordinates of the intersection between the slit 28a and the slit 28b at this time are recorded as (X0, Y1).

Then, the stage 14 is moved in the opposite direction, so as to move the slit 28 relatively toward the left in FIG. 12. When the light point P (256, 1024) passes through the right side slit 28a and is detected by the photodetector, as indicated by the broken lines in FIG. 12, the stage 14 is stopped. The coordinates of the intersection between the slit 28a and the slit 28b at this time are recorded as (X0, Y2).

From the measurement results, the coordinates (X, Y) of the light point P (256, 1024) are determined to be X=X0+(Y1−Y2)/2 and Y=(Y1+Y2)/2.

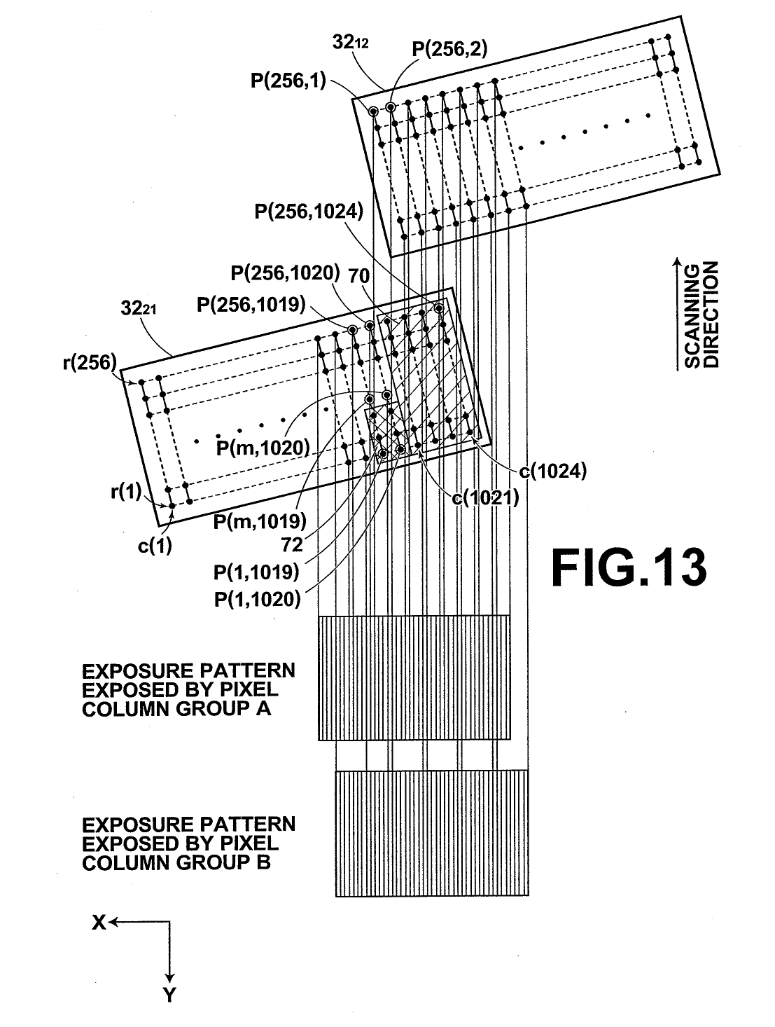

When selecting pixels to be utilized within the connecting portion in the example of FIG. 10, first, the position of a light point P (256, 1) is detected by the aforementioned combination of a slit 28 and a photodetector. Next, the positions of light points along a light point row r (256) within the exposure area 32₂₁ are detected sequentially, from P (256, 1024), P (256, 1023) . . . . When a light point P (256, n) having a greater X coordinate than that of the light point P (256, 1), the detecting operation is ceased. Then, the micro mirrors corresponding to a light point column c (n+1) through the light point column c (1024) are designated as those which are not to be utilized during final exposure. In the example of FIG. 10, consider a case in which the light point P (256, 1020) within the exposure area 32₂₁ has a greater X coordinate value than the light point P (256, 1) within the exposure area 32₁₂ and detection is ceased. In this case, micro mirrors corresponding to light points that constitute the light point columns c (1021) through c (1024) within the exposure area 32₂₁, indicated by the hatched portion 70 of FIG. 13, are designated as those which are not to be utilized during final exposure.

Next, the position of a light point P (256, N) within the exposure area 32₁₂ is detected, with respect to the number N of exposure. In the present embodiment, N=2, and therefore the position of a light point P (256, 2) is detected. Thereafter, thereafter, the positions of the light points within the rightmost light point column c (1020) of the exposure area 32₂₁, excluding those corresponding to the micro mirrors that were designated as those which are not to be utilized, are detected sequentially from P (1, 1020), P (2, 1020) . . . . The detection operation is ceased when a light point P (m, 1020) within the exposure area 32₂₁ which has an X coordinate greater than that of the light point P (256, 2) within the exposure area 32₁₂ is detected. Next, the computer connected to the photodetector compares the X coordinates of the light point P (256, 2) within the exposure area 32₁₂, the light point P (m, 1020) within the exposure area 32₂₁, and a light point (m−1, 1020) within the exposure area 32₂₁. In the case that the X coordinate of the light point P (m, 1020) is closer to the X coordinate of the light point P (256, 2), micro mirrors corresponding to light points P (1, 1020) through P (m−1, 1020) within the exposure area 32₂₁ are designated as those which are not to be utilized during final exposure. In the case that the X coordinate of the light point P (m−1, 1020) is closer to the X coordinate of the light point P (256, 2), micro mirrors corresponding to light points P (1, 1020) through P (m−2, 1020) within the exposure area 32₂₁ are designated as those which are not to be utilized during final exposure. Similar detecting processes and micro mirror selecting processes are administered with respect to the positions corresponding to the light point P (256, N−1), that is, P (256, 1) within the exposure area 32₁₂, and light points that constitute a next light point column c (1019) within the exposure area 32₂₁. As a result, the micro mirrors indicated within the cross hatched portion 72 of FIG. 13 are additionally designated as those which are not to be used during final exposure. Signals that set the angles of these micro mirrors, which have been designated as those not to be used during final exposure, to the OFF state are sent to these micro mirrors. Therefore, these micro mirrors are not utilized during final exposure.

By selecting micro mirrors which are not to be utilized during final exposure in the manner described above, the redundantly exposed region at the connecting portion between the heads that expose the exposure areas 32₁₂ and 32₂₁ can be minimized during double exposure. In addition, portions which are insufficiently exposed during double exposure can also be minimized. As a result, uniform double exposure that approaches an ideal state can be realized, as illustrated in the lower portion of FIG. 13.

Note that when selecting light points within the cross hatched portion 72 of FIG. 13, micro mirrors corresponding to the light points P (1, 1020) through P (m−2, 1020) within the exposure area 32₂₁ may be designated as those which are not to be utilized during final exposure, without comparing the X coordinates of the light points P (m, 1020) and P (m−1, 1020). In this case, the redundantly exposed region at the connecting portion between the heads can be minimized, and micro mirrors to be used in final exposure can be selected such that portions which are insufficiently exposed during double exposure can be realized. Alternatively, micro mirrors corresponding to the light points P (1, 1020) through P (m−1, 1020) within the exposure area 32₂₁ may be designated as those which are not to be utilized during final exposure. In this case as well, the redundantly exposed region at the connecting portion between the heads can be minimized, and micro mirrors to be used in final exposure can be selected such that portions which are insufficiently exposed during double exposure can be realized. As a further alternative, the micro mirrors to be used in final exposure can be selected such that the number of light points within a redundantly exposed region and the number of light points within a portion which is insufficiently exposed during double exposure are equal.

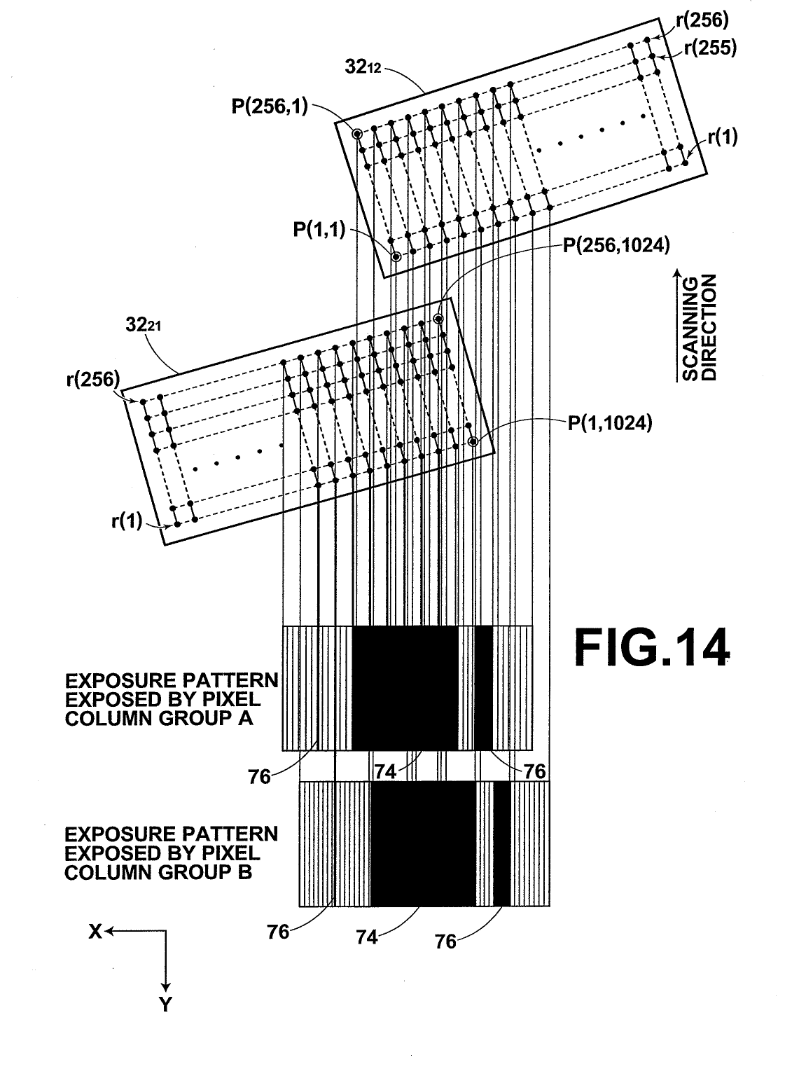

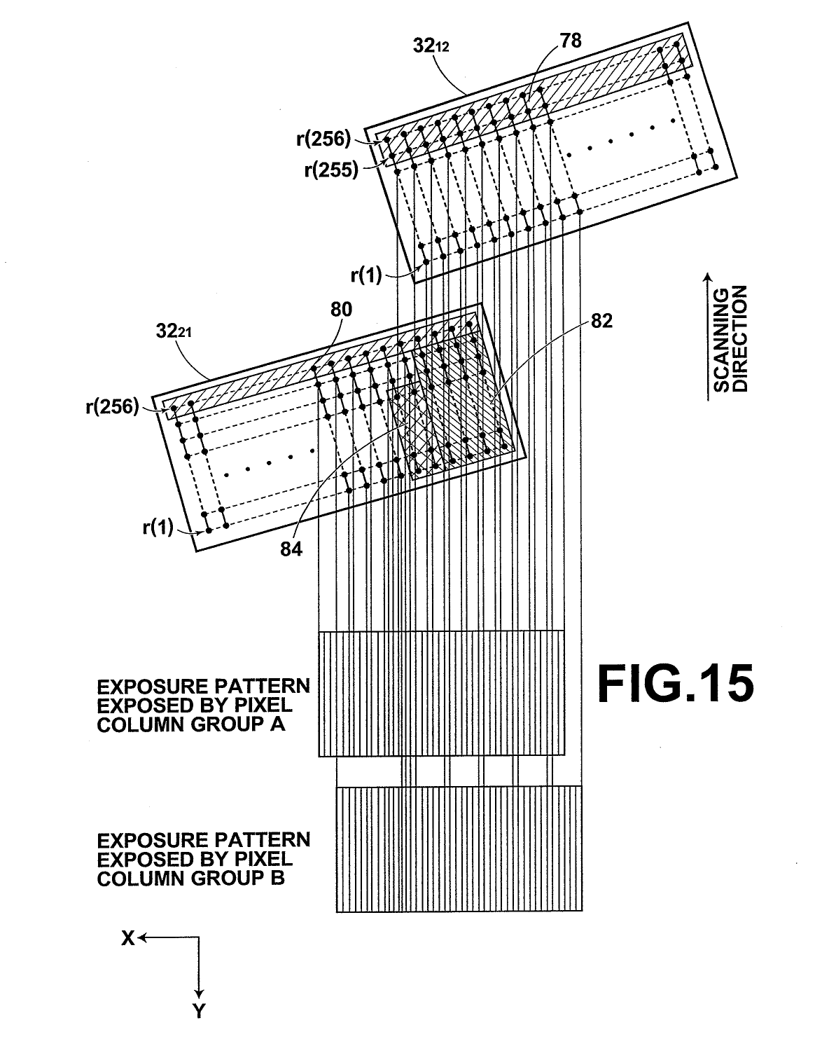

Next, an example of a pixel specifying process performed by a modified version of the exposure apparatus 10 of the present embodiment will be described with reference to FIGS. 14 and 15. This example takes margins of error in the mounting angles of each of the exposure heads 30₁₂ and 30₂₁ and misalignments in the relative mounting angles of the exposure heads 30₁₂ and 30₂₁ into consideration, in addition to the misalignment in the relative positions of the exposure heads 30₁₂ and 30₂₁, which was corrected for in the pixel selecting process described with reference to FIGS. 10 through 13. This example minimizes the influence of the above misalignments in the mounting angles, to further reduce irregularities in resolution and density on the exposure surface.

This modified version of the exposure apparatus 10 also performs double exposure. However, the set inclination angle of the exposure heads 30, that is, the DMD's 36, is slightly greater than the ideal angle θ_{ideal} that satisfies Equation (1), and an angle of approximately 0.50 degrees is adopted. Although fine adjustments of the mounting angel of the exposure heads 30 are difficult, by adopting a set inclination angle greater than the ideal angle θ_{ideal}, the actual mounting angle of the exposure heads 30 will not be less than the ideal angle θ_{ideal}, even if there is some margin of error in the mounting angle. The exposure apparatus 10 is initially adjusted within an adjustable range, such that the mounting angle of each exposure head 30, that is, each DMD 36, approximates the set inclination angle θ.

FIG. 14 is a diagram that illustrates an example of irregularities in patterns which are formed on an exposure surface, in the case that the relative positions of adjacent exposure heads (exposure heads 30₁₂ and 30₂₁, for example) are misaligned, there is a margin of error in the mounting angles thereof, and there is also misalignment in the relative angles thereof.

In the example of FIG. 14, a redundantly exposed region 74 that causes a density irregularity is generated at the connecting portion between the exposure areas 32₁₂ and 32₂₁, that is, the pattern exposed by the pixel column group A and the pattern exposed by the pixel column group B, due to the misalignment in the relative positions of the exposure heads 30₁₂ and 30₂₁ in the X direction, similarly to the case illustrated in FIG. 10. In addition, redundantly exposed regions 76 are generated in both the pattern exposed by the pixel column group A and the pattern exposed by the pixel column group B in regions other than the connecting portion between the exposure areas 32₁₂ and 32₂₁. The redundantly exposed regions 76 are generated by the set inclination angle θ for each exposure head being set greater than the angle θ_{ideal} that satisfies Equation (1), and also by the actual mounting angle being slightly different from the set inclination angle θ, due to the fact that it is difficult to perform fine adjustments of the mounting angles of the exposure heads. The redundantly exposed regions 76 are generated at portions corresponding to the ends of each pixel column, that is, at connecting portions among the pixel columns. The redundantly exposed regions 76 cause further density irregularities.

In this example, first, a usable pixel selecting process for reducing the density irregularities due to the margin of error in the mounting angles of the exposure heads 30₁₂ and 30₂₁ and due to the misalignment in the relative angles thereof is performed. Specifically, the combinations of the slits 28 and the photodetectors are employed to specify the actual inclination angle θ′ of the pixel columns which are projected onto the exposure surface. Then, micro mirrors which are to be utilized during final exposure are selected, based on the actual inclination angle θ′. The actual inclination angle θ′ of the exposure head 30₁₂ is specified by detecting the positions of light points P (1, 1) and P (256, 1) within the exposure area 32₁₂, and the actual inclination angle θ′ of the exposure head 30₂₁ is specified by detecting the positions of light points P (1, 1024) and P (256, 1024) within the exposure area 32₂₁, using combinations of the slits 28 and the photodetectors. The inclination angles of lines that connect the detected positions of the light points are calculated by the computer.

The actual inclination angles θ′ which are obtained in this manner are employed by the computer connected to the photodetectors to derive a natural number T closest to a value t that satisfies Equation (4):

tan θ′=t (4)

Then, micro mirrors from a (T+1)^{th} row to the 256^{th} row are designated as micro mirrors which are not to be used during final exposure. For example, consider a case in which a result of T=254 is derived for the exposure head 30₁₂ and a result of T=255 is derived for the exposure head 30₂₁. In this case, the micro mirrors corresponding to the light points that constitute the hatched portions 78 and 80 in FIG. 15 are designated as micro mirrors which are not to be used during final exposure. Thereby, the redundantly exposed regions at the regions other than the connecting portion between the heads that expose the exposure areas 32₁₂ and 32₂₁ can be minimized during double exposure. In addition, portions which are insufficiently exposed during double exposure can also be minimized.

Here, the smallest natural number T greater than or equal to the value of t may be derived instead of the natural number T closest to the value of t. In this case, the redundantly exposed regions at the regions other than the connecting portion between the heads that expose the exposure areas 32₁₂ and 32₂₁ can be minimized during double exposure. In addition, portions which are insufficiently exposed during double exposure can also be minimized. Alternatively, the greatest natural number T less than or equal to the value of t may be derived. In this case as well, the redundantly exposed regions at the regions other than the connecting portion between the heads that expose the exposure areas 32₁₂ and 32₂₁ can be minimized during double exposure. In addition, portions which are insufficiently exposed during double exposure can also be minimized. As a further alternative, the micro mirrors to be used in final exposure can be selected such that the number of light points within redundantly exposed regions and the number of light points within a portion which is insufficiently exposed during double exposure are equal.

Thereafter, the same usable pixel selecting process as that described with reference to FIGS. 10 through 13 may be administered with respect to micro mirrors corresponding to light points other than those within the hatched portions 78 and 80 of FIG. 15. Micro mirrors corresponding to light points within the hatched portion 82 and the cross hatched portion 84 in FIG. 15 are additionally designated as micro mirrors not to be utilized during final exposure. Signals that set the angles of these micro mirrors, which have been designated as those not to be used during final exposure, to the OFF state are sent to these micro mirrors. Therefore, these micro mirrors are not utilized during final exposure.

According to the modified version of the exposure apparatus 10 described above, uniform double exposure, in which irregularities in resolution and density are reduced across the entire exposure surface including the connecting portion between heads and the other regions, can be performed.

An embodiment and a modified version of the drawing apparatus of the present invention have been described in detail above. However, the above apparatuses described above are merely examples, and various changes are possible as long as they do not stray from the spirit and scope of the present invention.

For example, the combinations of the slits 28 and the photodetectors were used to detect the positions of light points on the exposure surface. The present invention is not limited to this configuration, and a two dimensional detector may be employed, for example.

In addition, in the embodiment and the modified version of the drawing apparatus described above, the computer connected to the photodetectors selected the micro mirrors to be utilized during final exposure, based on the detection results of the positions of the light points. A configuration, in which reference exposure is be performed employing all usable micro mirrors, and an operator manually specifies the micro mirrors to be utilized after visually confirming irregularities in resolution and density in the reference exposure results, is also included within the scope of the present invention.

Further, as a further modification to the above embodiment, reference exposure may be performed by micro mirrors that constitute every (N−1)^{th} pixel row, or by micro mirrors that constitute adjacent pixel rows that correspond to 1/N the total number of pixel rows, from among the usable micro mirrors of the DMD 36 of each exposure head 30. Thereafter, micro mirrors which are not to be utilized during final exposure may be selected from among the micro mirrors that were employed during the reference exposure corresponding to light points within connecting portions between heads, such that an ideal state that approximates single exposure can be realized.

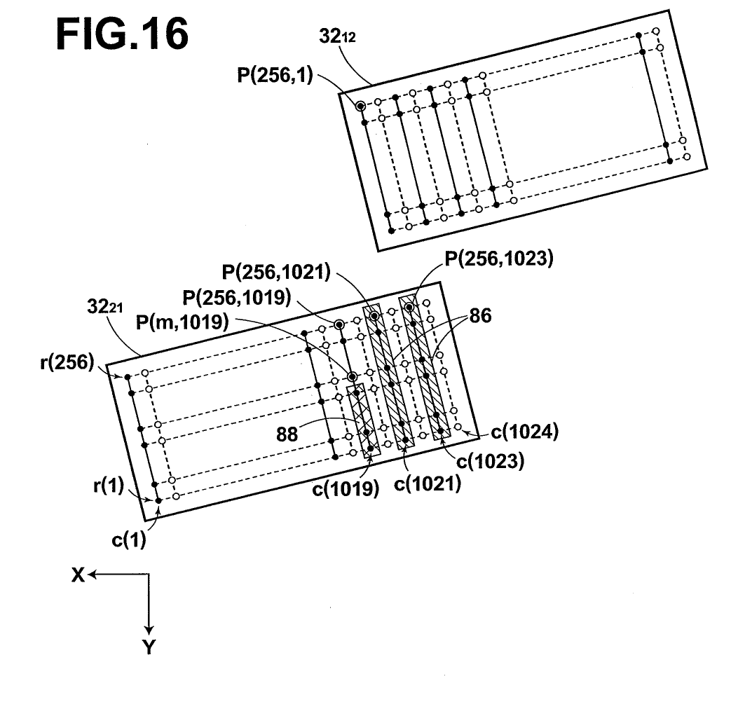

FIG. 16 is a diagram for explaining an example of an exposure apparatus, in which reference exposure using only micro mirrors that constitute every (N−1)^{th} pixel row is performed. In this example, the final exposure is double exposure, and therefore, N=2. First, reference exposure is performed using only micro mirrors corresponding to odd light point columns indicated by solid lines in FIG. 16, of two exposure heads (for example, exposure heads 30₁₂ and 30₂₁), which are adjacent to each other in the X direction. Then, the reference exposure results are output as a sample. An operator visually confirms irregularities in resolution and density or estimates the actual inclination angles by viewing the output reference exposure results. Thereafter, the operator can specify micro mirrors to be utilized during final exposure such that the irregularities in resolution and density are minimized within the connecting portion between the heads. For example, the micro mirrors corresponding to the odd numbered light point columns other than those within the hatched portion 86 and the cross hatched portion 88 of FIG. 16 may be selected as those to be utilized during final exposure. Regarding the even numbered pixel columns, reference exposure may be performed using only the even numbered pixel columns, then the micro mirrors to be utilized during final exposure may be specified. Alternatively, the same pattern of micro mirrors as that used for the odd numbered pixel columns may be applied to the even numbered pixel columns. By specifying the micro mirrors from among the odd numbered and even numbered micro mirror columns to be utilized during final exposure in this manner, a state that approximates ideal double exposure can be realized within the connecting portion between the heads. Note that the analysis of the sample exposure results is not limited to being performed by the operator by visual confirmation. As an alternative, mechanical analysis may be performed. Note that in FIG. 16, the odd numbered columns of the exposure head 30₁₂ and the odd numbered columns of the exposure head 30₂₁ are continuous. Therefore, odd numbered pixel column thinning reference exposure was described with reference to FIG. 16. However, the present invention is not limited to this configuration, and even numbered pixel column thinning reference exposure may be performed for one of the exposure heads, while odd numbered pixel column thinning reference exposure may be performed for the other exposure head.

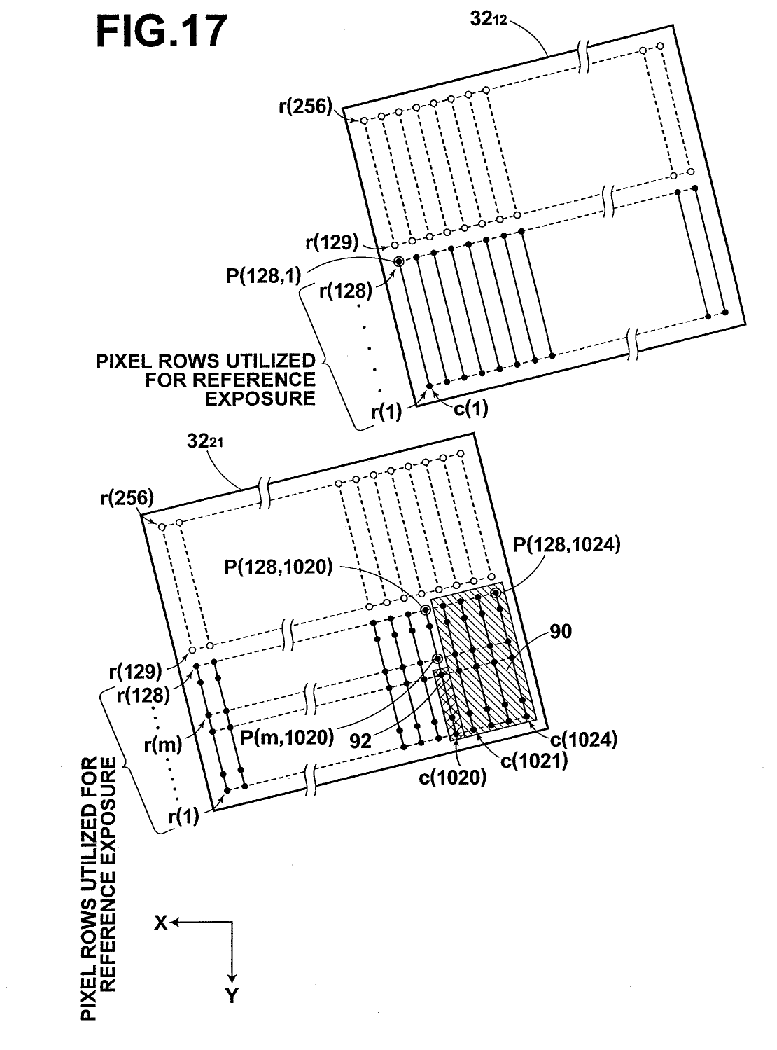

FIG. 17 is a diagram for explaining an example of an exposure apparatus, in which reference exposure using only micro mirrors that constitute adjacent pixel rows that correspond to 1/N the total number of pixel rows is performed. In this example, the final exposure is double exposure, and therefore, N=2. First, reference exposure is performed using only 128 (=256/2) micro mirrors from a first row indicated by the solid lines in FIG. 17, of two exposure heads (for example, exposure heads 30₁₂ and 30₂₁), which are adjacent to each other in the X direction. Then, the reference exposure results are output as a sample. An operator visually confirms irregularities in resolution and density or estimates the actual inclination angles by viewing the output reference exposure results. Thereafter, the operator can specify micro mirrors to be utilized during final exposure such that the irregularities in resolution and density are minimized within the connecting portion between the heads. For example, the micro mirrors corresponding to light points other than those within the hatched portion 90 and the cross hatched portion 92 of FIG. 17 may be selected as those to be utilized during final exposure. Regarding the micro mirrors of the 129^{th} through 256^{th} rows, separate reference exposure may be performed using only these micro mirrors, then the micro mirrors to be utilized during final exposure may be specified. Alternatively, the same pattern of micro mirrors as that used for the 1^{st} row through the 128^{th} row may be applied to the micro mirrors of the 129^{th} through 256^{th} rows. By specifying the micro mirrors to be utilized during final exposure in this manner, a state that approximates ideal double exposure can be realized within the connecting portion between the heads. Note that the analysis of the sample exposure results is not limited to being performed by the operator by visual confirmation. As an alternative, mechanical analysis may be performed.

Cases in which the final exposure is double exposure have been described in the above embodiment and the modified versions of the drawing apparatus. However, the present invention is not limited to this configuration, and single exposure or multiple exposure may be performed to any number N. However, it is preferable for multiple exposure to be performed at N×, wherein N is a number greater than or equal to 2, in order to further reduce irregularities in the resolution and density of two dimensional patterns on the drawing surface by compensation. Well balanced exposure that realizes both high resolution and reduced irregularities in resolution and density can be achieved by multiple exposure on the order of triple through septuple exposure.

The selection of usable pixels within the connecting portion between heads may be that which designates pixels within only one of the exposure heads that expose the connecting portion as those which are not to be utilized during final exposure, as described with reference to FIG. 13. Alternatively, the pixels which are not to be utilized during final exposure may be shared between two exposure heads.

Here, an example of a method, by which such an exposure apparatus specifies micro mirrors to be utilized during final exposure based on the results of reference exposure, will be described.

Specifically, the amount of misalignment of the relative positions of two exposure heads (exposure heads 30₁₂ and 30₂₁, for example) from an ideal state is measured. Then, the micro mirrors to be utilized are specified based on the measured amount of misalignment. First, the method by which the amount of misalignment is measured will be described.

When measuring the amount of misalignment, a line that extends in the X direction is exposed by micro mirrors of the exposure heads 30₁₂ and 30₂₁ that constitute every (N−1)^{th} pixel column. That is, exposure is performed such that the exposed points, which are exposed by the micro mirrors that constitute each pixel column of the exposure heads 30₁₂ and 30₂₁, extend in the X direction. Note that the exposure method that only utilizes micro mirrors that constitute every (N−1)^{th} pixel column as described above will hereinafter be referred to as “pixel skipping reference exposure”.

Exposure of the line that extends in the X direction is performed without utilizing micro mirrors of the exposure head 30₂₁ that correspond to a predetermined number of pixels (hereinafter, referred to as a “predetermined interval image”)

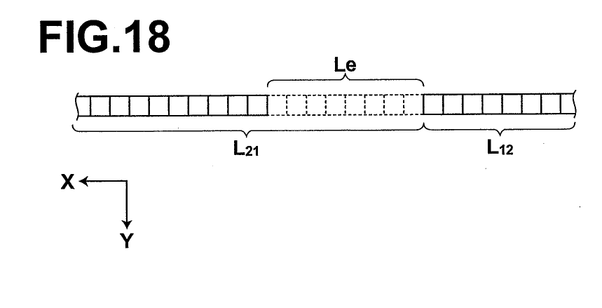

FIG. 18 illustrates a portion of a light that extends in the X direction which has been exposed as described above. Note that FIG. 18 illustrates the region of the line at which it is expected that the possibility that redundant exposure by the exposure heads 30₂₁ and 30₁₂ or insufficient exposure will occur is high. The line segment L₂₁ in FIG. 18 is that which is exposed by the exposure head 30₂₁, and the line segment L₁₂ in FIG. 18 is that which is exposed by the exposure head 30₁₂. The line segment Le between the line segments L₂₁ and L₁₂ is a portion of the line which should be exposed by micro mirrors corresponding to the predetermined interval image (hereinafter, referred to as “interval Le”, because exposure is not actually performed).

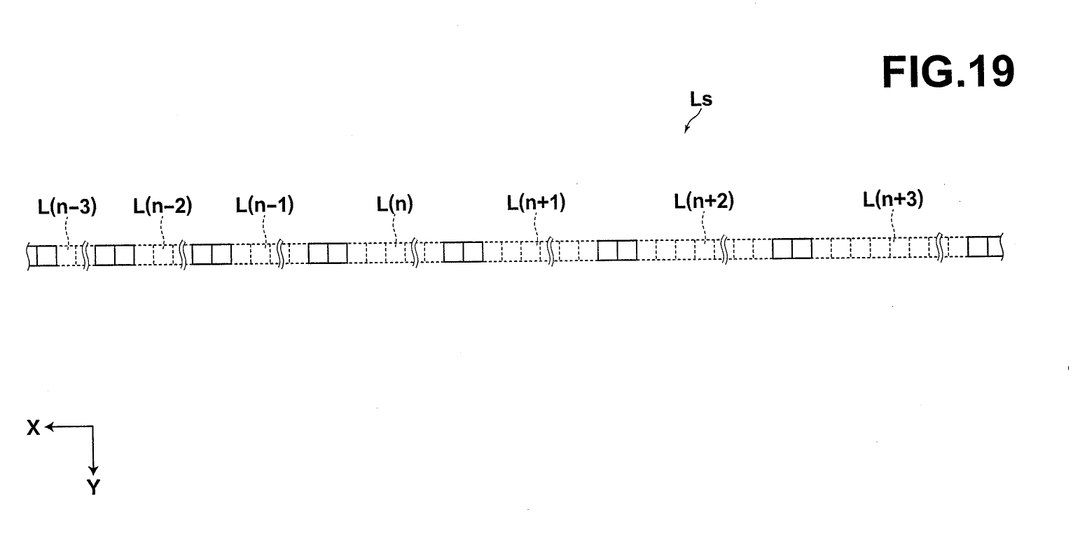

Exposure is performed without utilizing the micro mirrors corresponding to the predetermined interval image. At the same time, a reference scale Ls is exposed by either one of the exposure heads 30₁₂ and 30₂₁, as illustrated in FIG. 19. The reference scale Ls is a line that extends in the X direction, exposed by micro mirrors that constitute pixel columns of the exposure head 30₁₂ or the exposure head 30₂₁. The reference scale Ls is constituted by intervals L(n), L(n+1), L(n+2), L(n+3), L(n−1), L(n−2), and L(n−3), corresponding to numbers of exposure points (numbers of pixels) n, n+1, n+2, n+3, n−1, n−2, and n−3, which are arranged in the X direction for every predetermined number of exposure points. Note that the reference scale Ls may be exposed by either one or both of the exposure head 30₁₂ and the exposure head 30₂₁. In addition, the reference scale Ls may be exposed as a portion of the line segments L₂₁ and L₁₂ illustrated in FIG. 18, or separately therefrom. This reference scale Ls is also exposed by pixel skipping reference exposure.

The number of exposure points n within the interval L(n) of the reference scale Ls is set to be the same number as the number of micro mirrors that correspond to the predetermined interval image. Therefore, the number of micro mirrors that corresponds to the aforementioned misalignment can be measured, by comparing the length of the interval Le and the lengths of the intervals L.

For example, in the case that the length of the interval Le is equal to the length of the interval L(n), the amount of misalignment is zero. In the case that the length of the interval Le is equal to the length of the interval L(n−3), the number of micro mirrors that corresponds to the amount of misalignment is three. Accordingly, the exposure region of the exposure head 30₂₁ overlaps the exposure region of the exposure head 30₁₂ for a region corresponding to three micro mirrors. In this case, micro mirrors corresponding to light points P (m, 1019), P (m+1, 1019), and P (m+2, 1019) as illustrated in FIG. 16 may be designated as those which are not to be utilized during final exposure.

In the case that the length of the interval Le is equal to the length of the interval L(n+2), the number of micro mirrors that corresponds to the amount of misalignment is two. Accordingly, the exposure region of the exposure head 30₂₁ is separated from the exposure region of the exposure head 30₁₂ by an interval corresponding to two micro mirrors. In this case, micro mirrors corresponding to light points P (m−1, 1019), and P (m−2, 1019) as illustrated in FIG. 16 may be designated as those which are to be utilized during final exposure.

Note that the comparison of the length of the interval Le and the lengths of the intervals L may be performed by visual inspection, or measured by a predetermined measuring apparatus.

As described above, the micro mirrors to be utilized during final exposure can be specified based on the pixel thinning reference exposure results.

In the above description, the micro mirrors to be utilized are specified in both the exposure head 30₂₁ and the exposure head 30₁₂, to eliminate irregularities in exposure patterns due to the misalignment in the relative positions of the exposure heads in the X direction. However, even if the micro mirrors to be utilized are specified for each of the exposure heads, if the exposure timings of the exposure head 30₂₁ and the exposure head 30₁₂ are not appropriate, the exposure patterns which are exposed onto the exposure surface by the exposure head 30₂₁ and the exposure head 30₁₂ will become misaligned in the Y direction.

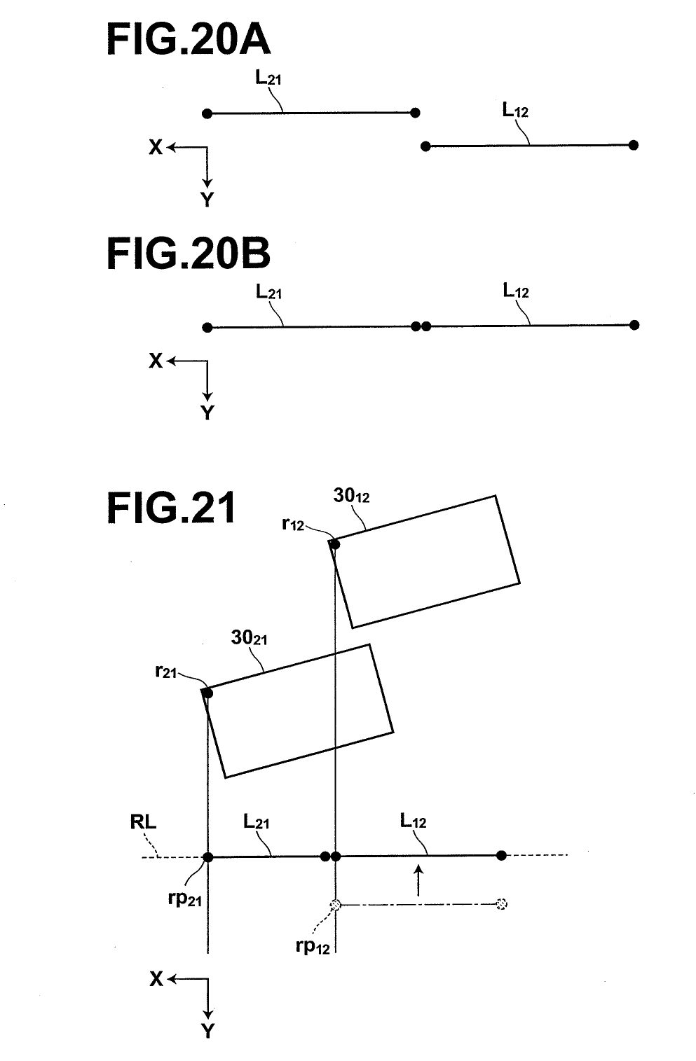

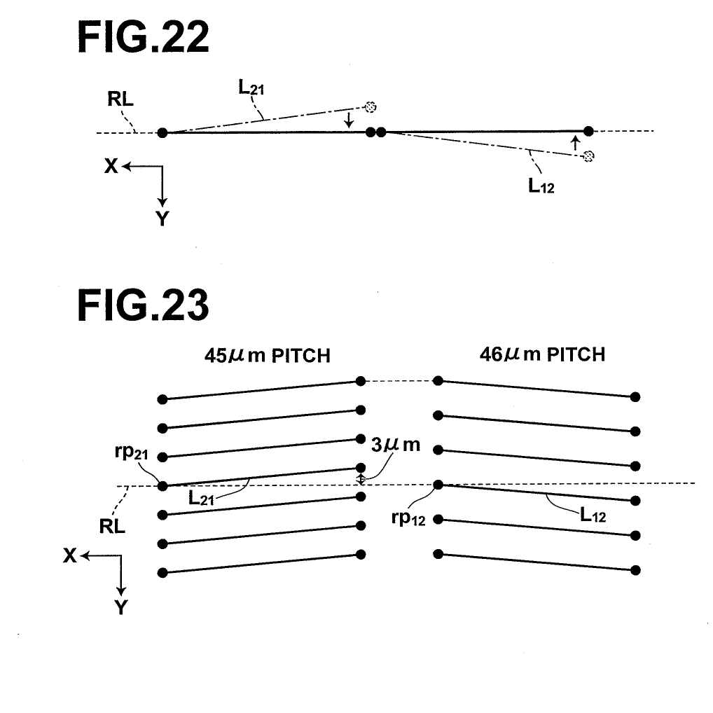

For example, consider a case in which the lines segments L₂₁ and L₁₂ that extend in the X direction are exposed by the exposure head 30₂₁ and 30₁₂, respectively. In this case, if the exposure timing of each exposure head is not appropriate, the line segments L₂₁ and L₁₂ will become misaligned in the Y direction, as illustrated in FIG. 20A.

Accordingly, it is desirable for the exposure timings of the exposure heads 30₂₁ and 30₁₂ to be controlled such that the line segments L₂₁ and L₁₂ are connected without being misaligned in the Y direction, as illustrated in FIG. 20B.

Specifically, for example, the position of the micro mirror that corresponds to the exposure point at the right end of the line segment L₂₁ and the position of the micro mirror that corresponds to the exposure point at the left end of the line segment L₁₂ may be measured by combinations of the slits 28 and the photodetectors, for example. Then, the distance between the micro mirrors in the Y direction may be calculated, and exposure timings for the exposure heads 30₂₁ and 30₁₂ that enable exposure enable that the line segments L₂₁ and L₁₂ are connected without becoming misaligned in the Y direction may be derived, based on the distance and the moving speed of the stage 14.

However, the method for controlling the exposure timings is not limited to that described above. Alternatively, the line segments L₂₁ and L₁₂ may be exposed by the exposure heads 30₂₁ and 30₁₂ at preset exposure timings. Then, the amount of misalignment between the line segments L₂₁ and L₁₂ in the Y direction may be measured by a measuring means, and the exposure timings may be adjusted based on the measured amount of misalignment.

As a further alternative, reference micro mirrors r₂₁ and r₁₂ may be set in the exposure heads 30₂₁ and 30₁₂, as illustrated in FIG. 21. In this case, the exposure timings of the exposure heads 30₂₁ and 30₁₂ may be adjusted such that exposure points rp₂₁ and rp₁₂ which are exposed by the reference micro mirrors r₂₁ and r₁₂ are positioned along a reference line RL which is set on the exposure surface in advance.

When measuring the amount of misalignment in the Y direction as described above, there may be cases in which the scanning directions of micro mirrors are not aligned in the Y direction. In these cases, a line may be drawn in the scanning direction by a predetermined micro mirror, and the line may be used as a reference to perform measurement of the exposure positions of the reference micro mirror of each exposure head. For example, if the angle of the scanning direction with respect to the X direction is set, a virtual line may be set with respect to the scanning direction. Then, the exposure positions may be measured in terms of amounts of misalignment with respect to the virtual line. Note that rough adjustments may be performed such that the positions and angles of exposure patterns are set with respect to the virtual line.

Note that a micro mirror which is at the same position within the DMD of each exposure head is specified as the reference micro mirror. For example, micro mirrors which correspond to the exposure point at the left ends of the line segments L₂₁ and L₁₂ may be set as the reference micro mirrors, as illustrated in FIG. 21. As a method for adjusting the exposure timings such that the exposure points rp₂₁ and rp₁₂ which are exposed by the reference micro mirrors r₂₁ and r₁₂ are positioned along a reference line RL, the line segments L₂₁ and L₁₂ may be exposed by the exposure heads 30₂₁ and 30₁₂ at preset exposure timings. Then, the positional relationship among the reference line RL, the exposure point rp₂₁ and the exposure point rp₁₂ may be measured by a measuring means. Thereafter, the exposure timings may be adjusted based on the measured positional relationships and the moving speed of the stage 14.

The reference line RL may be set on the exposure surface in advance. Alternatively, a line parallel to the X direction (perpendicular to the scanning direction) that passes through the light point corresponding to the reference micro mirror of a first exposure head may be set as the reference line RL. The exposure timings of other exposure heads may be adjusted such that the light points corresponding to the reference micro mirrors thereof are positioned on the reference line RL. Note that the exposure head 30₁₁ illustrated in FIG. 3B may be specified as the first exposure head, for example.

Even if exposure is performed by the exposure heads 30₂₁ and 30₁₂ such that the light points corresponding to the reference micro mirrors thereof are positioned on the reference line RL, there may be cases in which the actual inclination angle of the DMD of the exposure head 30₂₁ or 30₁₂ is shifted form the set inclination angle. In these cases, the line segments L₂₁ and L₁₂ will not be parallel to the X direction. That is, the exposure pattern exposed by the exposure head 30₂₁ and the exposure pattern exposed by the exposure head 30₁₂ will become those which are rotated with the reference micro mirrors thereof as the centers of rotation.

In these cases, the amount of rotational shifting with the reference micro mirror at the center of rotation may be measured for each exposure head. Then, rotation processes may be administered onto exposure image data that represent exposure patterns to be exposed by the exposure heads. Thereby, the exposure pattern exposed by the exposure head 30₂₁ (the line segment L₂₁, for example) and the exposure pattern exposed by the exposure head 30₁₂ (the line segment L₁₂, for example) may be cause to connect at the same position in the Y direction. Note that the amount of rotational shifting may be obtained by exposing the line segments L₂₁ and L₁₂ with the exposure heads 30₂₁ and 30₁₂, then measuring the angles that the line segments L₂₁ and L₁₂ form with respect to the X direction with a measuring means. Here, the rotation process may be that which rotates the image data that represents the exposure patterns. Alternatively, the rotation process may be that which controls the timings of each column of the exposure heads (for example, from the first column to the 1024^{th} column) to expose a rotated exposure pattern.

It is not necessary for the measuring means to actually measure the angle. Alternatively, the light points rp₂₁ and rp₁₂ corresponding to the reference micro mirrors r₂₁ and r₁₂ of the exposure heads 30₂₁ and 30₁₂ may expose the line segments L₂₁ and L₁₂ at exposure timings such that the line segments L₂₁ and L₁₂ are positioned on the reference line RL. Then, a plurality of line segments which are respectively parallel to the line segments L₂₁ and L₁₂ may be exposed at different pitches in the Y direction. The amount of rotational shifting may be obtained based on the exposed pattern. As a specific example, a plurality of line segments parallel to the line segment L₂₁ may be exposed by the exposure head 30₂₁ at a pitch of 45 μm, and a plurality of line segments parallel to the line segment L₁₂ may be exposed by the exposure head 30₁₂ at a pitch of 46 μm, as illustrated in FIG. 23. Then, a line segment exposed by the exposure head 30₁₂, of which the light point at the leftmost end matches the position of the rightmost end of a line segment exposed by the exposure head 30₂₁ in the Y direction, is found. The ordinal number of the line segment when counted from the line segment L₁₂ is obtained. In the case that the line segment that satisfies the above condition is the third line segment from the line segment L₁₂ as illustrated in FIG. 23, it is judged that the light point at the rightmost end of the line segment L₂₁ is misaligned from the reference line RL by 3 μm, based on the measuring principle of calipers. Then, the above misalignment is converted to a rotational angle of the line segment L₂₁ with the light point rp₂₁ as the center of rotation, and the aforementioned rotation process may be administered on the exposure image data based on the rotational angle.

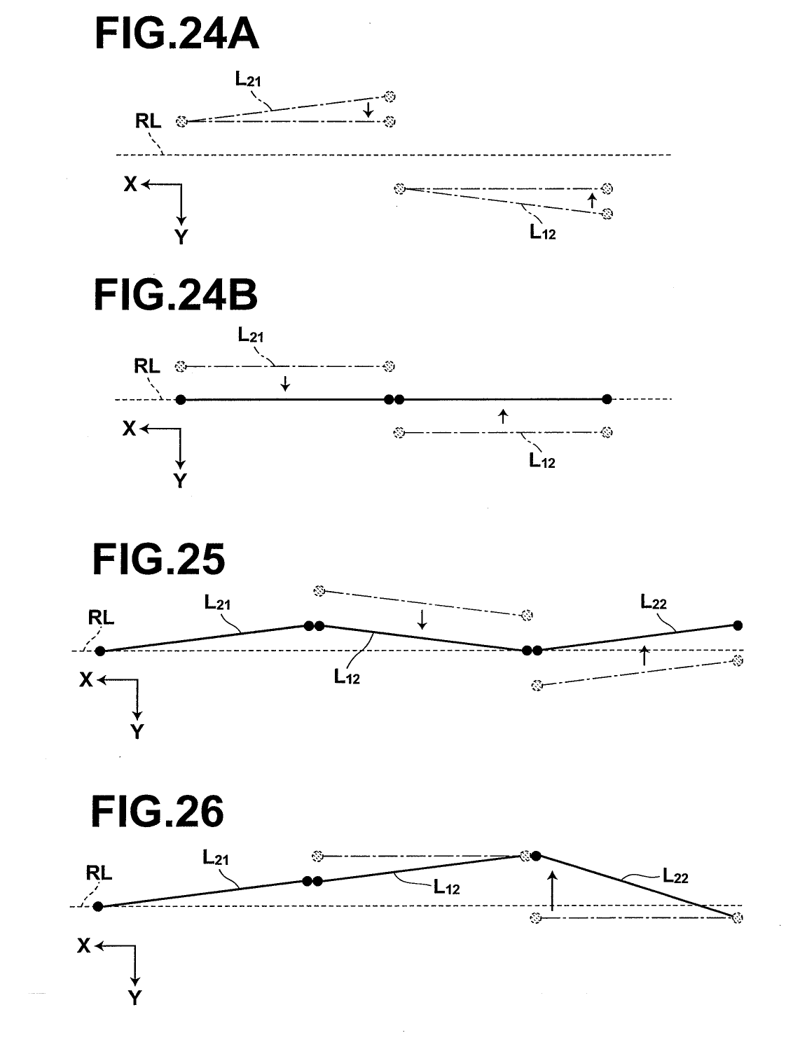

In the foregoing description, the exposure timings were set such that the exposure points rp₂₁ and rp₁₂ exposed by reference micro mirrors r₂₁ and r₁₂ of the exposure heads 30₂₁ and 30₁₂ are positioned on the reference line RL. Then, the amounts of rotational shifting of the line segment L₂₁ exposed by the exposure head 30₂₁ and of the line segment L₁₂ exposed by the exposure head 30₁₂ with respect to the X direction were measured. Thereafter, the rotation process was administered on the exposure image data based on the amounts of rotational shifting. However, the order of the setting of the exposure timings and the administration of the rotation process may be reversed. Specifically, the line segments L₂₁ and L₁₂ may be exposed at preset exposure timings, as illustrated in FIG. 24A. Then, the amounts of rotational shifting of the line segments L₂₁ and L₁₂ with respect to the X direction may be measured, and rotation processes may be administered on the exposure image data. Thereafter, the line segments L₂₁ and L₁₂ may be exposed by the exposure heads 30₂₁ and 30₁₂, as illustrated in FIG. 24B. Next, the amount of misalignment of the line segments L₂₁ and L₁₂ with respect to the reference line RL in the Y direction may be measured, and the preset exposure timing may be adjusted according to the measured amount of misalignment, such that the line segments L₂₁ and L₁₂ are positioned on the reference line RL.

As a further alternative, only the exposure timings may be adjusted without administering the aforementioned rotation processes, and the positions of the rightmost end of the line segment L₂₁ and the leftmost end of the line segment L₁₂ may be caused to match in the Y direction, as illustrated in FIG. 25. Specifically, the line segments L₂₁ and L₁₂ may be exposed by the exposure heads 30₂₁ and 30₁₂ at preset exposure timings. Then, the amount of misalignment between the light point at the rightmost end of the line segment L₂₁ and the light point at the leftmost end of the light segment L₁₂ in the Y direction may be measured by a measuring means. Thereafter, the exposure timings may be adjusted based on the measured amount of misalignment, such that the positions of the light point at the rightmost end of the line segment L₂₁ and the light point at the leftmost end of the light segment L₁₂ match in the Y direction. Note that in the case that the exposure patterns exposed by each exposure head are connected in the manner described above, it is desirable for the exposure timing of at least one of the exposure heads to be such that an exposure point corresponding to the reference micro mirror thereof is positioned on the reference line RL. In the example illustrated in FIG. 25, the exposure point exposed by the reference micro mirror of the exposure head 30₂₁ is positioned on the reference line RL.

As a still further alternative, only the rotation processes may be administered without adjusting the exposure timings, and the positions of the rightmost end of the line segment L₂₁ and the leftmost end of the line segment L₁₂ may be caused to match in the Y direction. Specifically, the line segments L₂₁ and L₁₂ may be exposed by the exposure heads 30₂₁ and 30₁₂ at preset exposure timings. Then, the amount of misalignment between the exposure point at the rightmost end of the line segment L₂₁ and the exposure point at the leftmost end of the light segment L₁₂ in the Y direction may be measured by a measuring means, or by using the plurality of line segment patterns as illustrated in FIG. 23. Thereafter, a rotation process may be administered on the exposure image data that represents the line segment L₁₂ based on the measured amount of misalignment, such that the positions of the exposure point at the rightmost end of the line segment L₂₁ and the exposure point at the leftmost end of the light segment L₁₂ match in the Y direction. Then, the line segment L₁₂ may be exposed using the exposure image data, on which the rotation process has been administered. Further, regarding the exposure image data for the exposure head 30₂₂, a rotation process may be administered so as to cause the positions of the exposure point at the rightmost end of the line segment L₁₂ and the exposure point at the leftmost end of the light segment L₂₂ to match in the Y direction. Note that in the case that the exposure patterns exposed by each exposure head are connected in the manner described above as well, it is desirable for the exposure timing of at least one of the exposure heads to be such that an exposure point corresponding to the reference micro mirror thereof is positioned on the reference line RL. In the example illustrated in FIG. 26, the exposure point exposed by the reference micro mirror of the exposure head 30₂₁ is positioned on the reference line RL.

As still another alternative, a micro mirror of an exposure head may expose a scanning direction reference line along the scanning direction. At the same time, each exposure head may expose lines in predetermined directions. Thereafter, rotation processes may be administered such that the lines extending in the predetermined directions are properly aligned, using the scanning direction reference line as a reference.

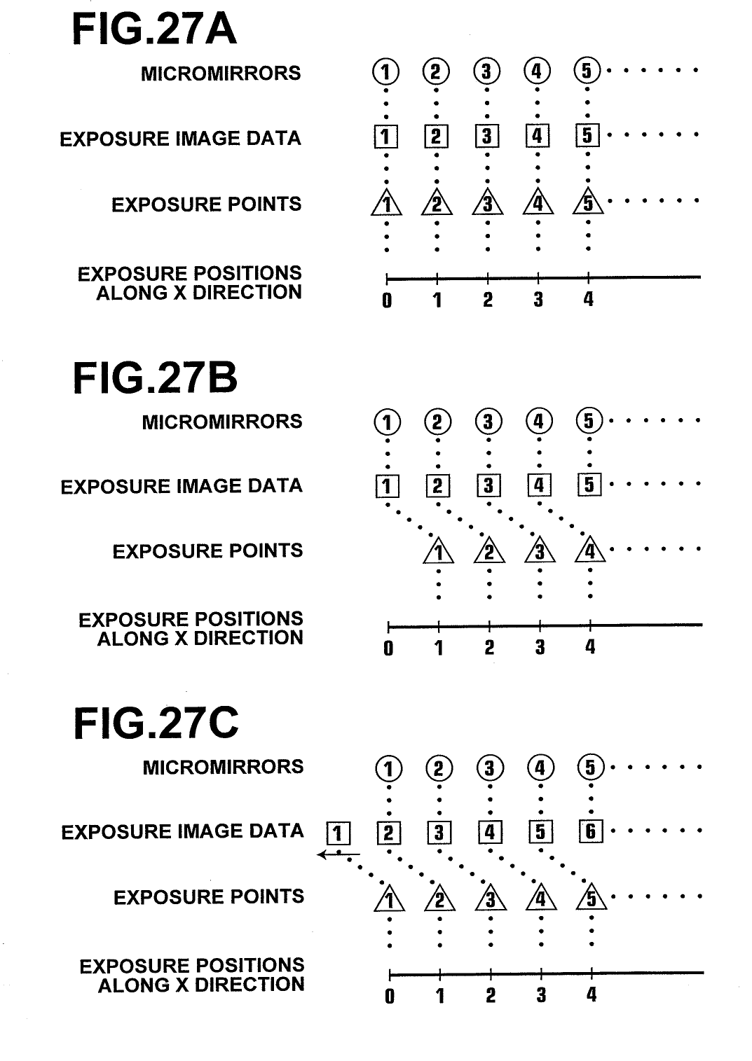

When specifying micro mirrors to be utilized in each exposure head and performing final exposure using the specified micro mirrors as described above, exposure image data are assigned to each micro mirror, such that desired exposure points corresponding to the exposure image data are exposed at desired exposure positions in the X direction. Specifically, for example, a piece of exposure image data 1 is assigned to a micro mirror 1 such that an exposure point 1 is positioned at position X=0, as illustrated in FIG. 27A.

However, even if the exposure image data are assigned in the manner described above, there are cases in which the positions of the exposure points become shifted in the X direction such that the exposure point 1 is positioned at position X=1, as illustrated in FIG. 27B. This shifting is due to misalignment in the installation positions of optical systems of the exposure heads, the properties of the exposure heads, and the like. In these cases, it is not possible to expose desired exposure patterns onto the photosensitive material 12.

Therefore, the exposure image data may be shifted in the X direction, then assigned to each micro mirror, as illustrated in FIG. 27C. Thereby, the image of each exposure point can be exposed at the desired position therefor. Note that the micro mirror, to which the exposure image data 1 is assigned, is not illustrated in FIG. 27C. If the micro mirror 1 is the micro mirror that exposes the light point at the edge of the exposure head, the exposure image data 1 may be assigned to a micro mirror of an adjacent exposure head. As a method for shifting then assigning the exposure image data to each micro mirror, a data shifting process may be administered as an image process onto the exposure image data itself, then the shifting processed exposure image data may be assigned to the micro mirrors. Alternatively, a memory, in which the exposure image data is recorded, may be set such that readout addresses are shifted. Then, the exposure image data may be read out according to the shifted readout addresses, and assigned to the micro mirrors.

The amount of shifting of the exposure image data, when the exposure image data is shifted in the X direction and assigned to the micro mirrors, may be determined by the following steps, for example. A line segment L₂₁ may be exposed, as illustrated in FIG. 21, then the amount of shifting in the X direction of the reference point rp₂₁ exposed by the reference micro mirror r₂₁ may be measured by a measuring means. The shifting process may be administered or the readout addresses may be added to or subtracted from, based on the measured amount of shifting.

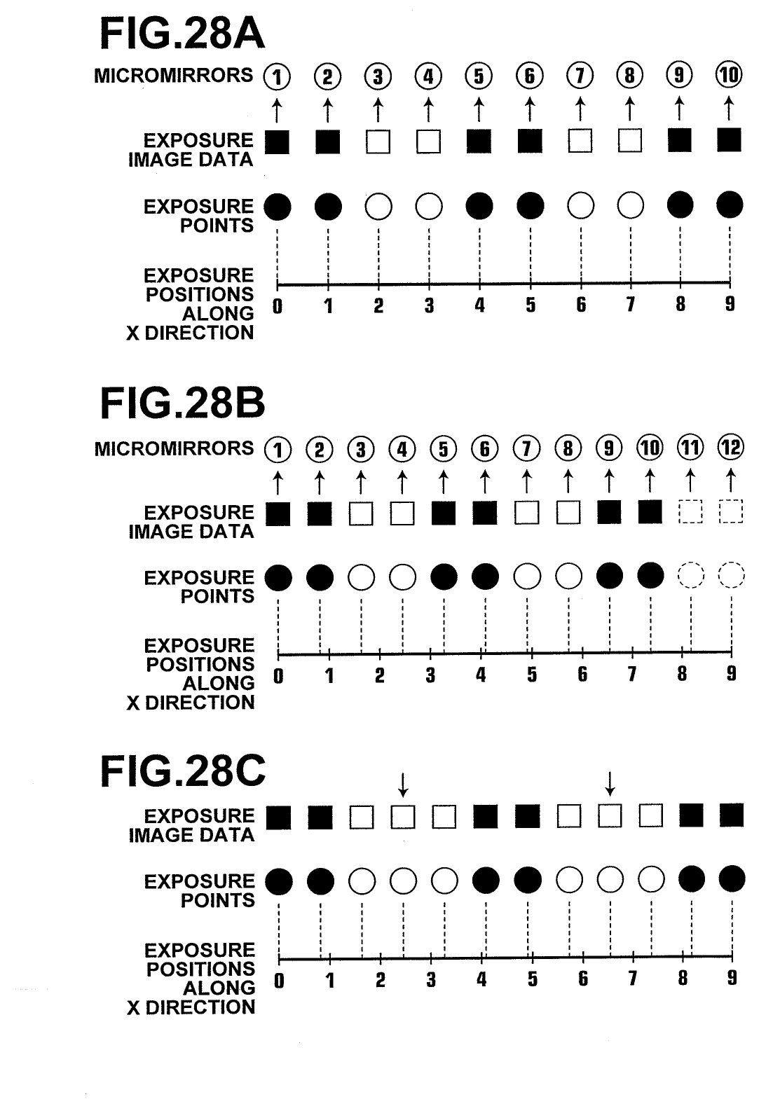

Here, the exposure image data are assigned to the micro mirrors of each exposure head based on a premise that exposure points exposed by micro mirrors 1 through 10 are positioned within positions 0 through 9 in the X direction, as illustrated in FIG. 28A. However, if the magnification ratio of the optical system of an exposure head is less than a designed value, the positions 0 through 9 in the X directions will be exposed by micro mirrors 1 through 12 as illustrated in FIG. 28B, for example. In this case, if the exposure image data are assigned based on the above premise, the exposed pattern will be reduced from a desired exposure pattern, as illustrated in FIG. 28B, the exposed pattern becomes distorted, and exposed patterns will not be connected among exposure heads. Note that exposure image data for an adjacent exposure head will be assigned to micro mirrors 11 and 12 illustrated in FIG. 28B.

Therefore, the exposure image data may be interpolated according to the difference in the magnification ratio of the optical system so as to expose the desired exposure pattern within the positions 0 through 9 in the X direction, as illustrated in FIG. 28C. Note that the pieces of exposure image data indicated by arrows in FIG. 28C are the interpolated pieces of exposure image data.

In the foregoing description, a process to be administered in the case that the magnification ratio of the optical system of an exposure head is less than the designed value has been described. In the case that the magnification ratio of an optical system of an exposure head is greater than a designed value, a number of pixels corresponding to the difference in the magnification ratio may be skipped in the exposure image data, then the exposure image data may be assigned to the micro mirrors.

A method for measuring the difference in the magnification ratio of the optical system of an exposure head will be described.

Here, a method for measuring the difference in the magnification ratio of the optical system of the exposure head 30₂₁ will be described. However, the differences in the magnification ratios of the optical systems of the other exposure heads may also be measured by the same method.

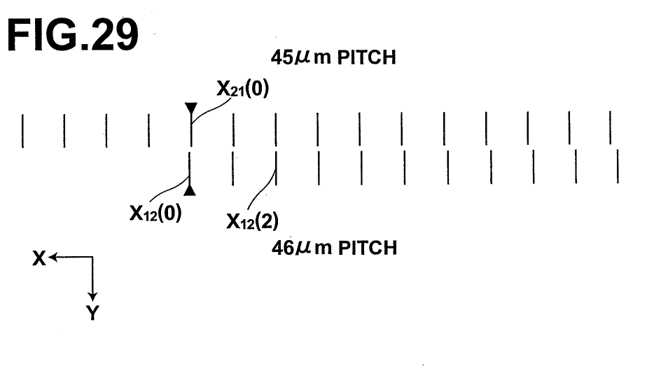

First, a first reference line segment X₁₂(0) that extends in the Y direction is exposed by the reference micro mirror r₁₂ of the exposure head 30₁₂, as illustrated in the lower portion of FIG. 29. Then, a plurality of line segments that extend in the Y direction are exposed by the exposure head 30₁₂ at a pitch of 46 μm from the first reference line segment X₁₂ (0) (hereinafter, these line segments will be referred to as a “first scaling pattern”). Meanwhile, a micro mirror of the exposure head 30₂₁ that exposes exposure points at the same position in the X direction as the exposure point rp₁₂ exposes a second reference line segment X₂₁(0). Then, a plurality of line segments that extend in the Y direction are exposed by the exposure head 30₂₁ at a pitch of 45 μm from the second reference line segment X₂₁(0) (hereinafter, these line segments will be referred to as a “second scaling pattern”).

Here, for example, in the case that the difference in the magnification ratio of the optical system of the exposure head 30₂₁ is zero, the positions of the first reference line segment X₁₂(0) and the second reference line segment X₂₁(0) will match in the X direction. However, the positions of the first reference line segment X₁₂ (0) and the second reference line segment X₂₁ (0) will not match in the case that there is a difference in the magnification ratio of the optical system of the exposure head 30₂₁. After the first and second scaling patterns are exposed, the line segment closest to the second reference line segment X₂₁(0) within the second scaling pattern that matches the position of a line segment within the first scaling pattern is found. In the example illustrated in FIG. 29, the position of the line segment X₁₂(2) within the first scaling pattern matches the position of a line segment within the second scaling pattern. Accordingly, it is judged that the positions of exposure points exposed by the exposure head 30₂₁ are misaligned 2 μm toward the right in the X direction, based on the measuring principle of calipers.

Accordingly, exposure can be performed by skipping pixels corresponding to the number of exposure points within a range of 2 μm in the exposure image data. In the case that the misalignment in the X direction is in a direction inverse to that described above, an interpolation process can be administered instead of the pixel skipping process.

The exposure apparatuses according to the embodiment and the modified versions described above may further comprise an image data converting mechanism. The image data converting mechanism may function to convert the exposure image data such that the dimensions of predetermined portions of the two dimensional patterns represented thereby match the dimensions which are capable of being exposed by the micro mirrors which are selected to be utilized during final exposure. By converting the exposure image data in this manner, finely detailed patterns corresponding to desired two dimensional patterns can be formed on the exposure surface.

The exposure apparatuses according to the embodiment and the modified versions described above utilized DMD's as pixel arrays for modulating light beams from the light source for each pixel. However, the present invention is not limited to this configuration, and light modulating elements other than DMD's, such as liquid crystal arrays, or light source arrays (LD arrays, organic EL arrays, and the like) may be employed.

The operation of the exposure apparatuses according to the embodiment and the modified versions described above may be that in which the exposure heads are constantly moved while continuously performing exposure. Alternatively, the operation of the exposure apparatuses may be that in which the exposure heads are moved in a stepwise manner, stopped at each incremented position, and perform exposure operations thereat.

The present invention is also not limited to an exposure apparatus and an exposure method. The present invention may be applied to any drawing apparatus or drawing method that employs a plurality of drawing heads to perform multiple drawing at N× (N is a natural number greater than or equal to 1) on a drawing surface. An example of such a drawing apparatus and such a drawing method is an ink jet printer and an ink jet printing method. Commonly, nozzles for ejecting drops of ink are formed on a nozzle surface of ink jet recording heads that face recording media (such as recording sheets and OHP sheets) of ink jet printers. There are ink jet printers, in which a plurality of nozzles are arranged in a matrix, and the head itself is inclined with respect to a scanning surface, to enable recording of images by multiple drawing. Consider a case in which the relative positions or angles among drawing heads are shifted from ideal states in an ink jet printer that adopts this type of two dimensional arrangement. In this case as well, the number of nozzles that minimizes the influence of the shifts from the ideal states can be selected as nozzles to be actually utilized, by applying the present invention. Therefore, irregularities in resolution and density can be reduced at the connecting portions among the image recording heads.

An embodiment and modified versions of the present invention have been described in detail above. However, the embodiment and modified versions are merely examples. The technical scope of the present invention is to be determined by the following claims.

1-16. (canceled)

17. A drawing method for performing drawing based on an image data set that represents an image, by:
moving a plurality of drawing heads relative to a drawing surface in a predetermined scanning direction, each of the drawing heads being equipped with a drawing point forming section, in which drawing elements for forming drawing points on the drawing surface are arranged two dimensionally;
forming the drawing points on the drawing surface sequentially, corresponding to the movement; and
performing drawing by the plurality of the drawing heads, which are arranged in a direction that intersects with the scanning direction; wherein:
reference points are formed on the drawing surface, by a reference point drawing element which is set in each of the drawing heads; and
the drawing timing of each of the drawing heads is controlled such that the reference points formed thereby are arranged at predetermined positions along the scanning direction.

18. A drawing method as defined in claim 17, wherein:
the reference point formed by each drawing head is positioned at an end of a partial image formed by the drawing head in the direction that intersects with the scanning direction.

19. A drawing method as defined in claim 18, wherein:
correction is administered on partial image data sets, which are input to the drawing heads, such that the end of a partial image formed by a drawing head at which the reference point is formed is connected to the end of a partial image formed by an adjacent drawing head at which the reference point is not formed.

20. A drawing method as defined in claim 19, wherein:
a rotation process is administered as the correction.

21. A drawing method as defined in claim 17, wherein:
correction is administered on partial image data sets, which are input to the drawing heads, such that images constituted by drawing points formed by the reference drawing elements are formed at predetermined positions along the direction that intersects the predetermined scanning direction.

22. A drawing method as defined in claim 17, wherein:
correction is administered on partial image data sets, which are input to the drawing heads, such that images formed on the drawing surface by adjacent drawing heads are connected in the direction that intersects the predetermined scanning direction.

23. A drawing method as defined in claim 22, wherein:
an interpolation process or a pixel skipping process is administered as the correction.

24. A drawing method as defined in claim 17, wherein:
multiple drawing is performed on the drawing surface at N× (N being a natural number greater than or equal to 2).

25. A drawing apparatus for performing drawing based on an image data set that represents an image, by:
moving a plurality of drawing heads relative to a drawing surface in a predetermined scanning direction, each of the drawing heads being equipped with a drawing point forming section, in which drawing elements for forming drawing points on the drawing surface are arranged two dimensionally;
forming the drawing points on the drawing surface sequentially, corresponding to the movement; and
performing drawing by the plurality of the drawing heads, which are arranged in a direction that intersects with the scanning direction; wherein:
the plurality of drawing heads form reference points on the drawing surface, with a reference point drawing element which is set in each of the drawing heads; and
the drawing apparatus further comprises a control section, for controlling the drawing timing of each of the drawing heads such that the reference points formed thereby are arranged at predetermined positions along the scanning direction.

26. A drawing apparatus as defined in claim 25, wherein:
each drawing head forms the reference point such that the reference point is positioned at an end of a partial image formed by the drawing head in the direction that intersects with the scanning direction.

27. A drawing apparatus as defined in claim 26, further comprising:
scanning direction correcting means, for administering correction on partial image data sets, which are input to the drawing heads, such that the end of a partial image formed by a drawing head at which the reference point is formed is connected to the end of a partial image formed by an adjacent drawing head at which the reference point is not formed.

28. A drawing apparatus as defined in claim 27, wherein:
the scanning direction correcting means administers a rotation process as the correction.

29. A drawing apparatus as defined in claim 25, further comprising:
drawing point correcting means, for administering correction on partial image data sets, which are input to the drawing heads, such that images constituted by drawing points formed by the reference drawing elements are formed at predetermined positions along the direction that intersects the predetermined scanning direction.

30. A drawing apparatus as defined in claim 25, further comprising:
intersecting direction correcting means, for administering correction on partial image data sets, which are input to the drawing heads, such that images formed on the drawing surface by adjacent drawing heads are connected in the direction that intersects the predetermined scanning direction.

31. A drawing apparatus as defined in claim 30, wherein:
the intersecting direction correcting means administers an interpolation process or a pixel skipping process as the correction.

32. A drawing apparatus as defined in claim 25, wherein:
multiple drawing is performed on the drawing surface at N× (N being a natural number greater than or equal to 2).
